(19) United States
(12) Patent Application Publication
(10) Pub. No.: US 2009/0250404 A1
(43) Pub. Date: Oct. 8, 2009

(54) DECONTAMINATING FLUIDS AND METHODS OF USE THEREOF

(76) Inventors: Brian Berkowitz, Mazkeret Batya (CA); Ishai Dror, Shoham (IL)

Correspondence Address: Pearl Cohen Zedek Latzer, LLP, 1500 Broadway, 12th Floor, New York, NY, 10036, US

(21) Appl. No.: 12/303,251

(22) PCT Filed: Jun. 4, 2007
(86) PCT No.: PCT/IL07/00678

§ 371 Date: Jun. 24, 2009

Related U.S. Application Data
(60) Provisional application No. 60/810,639, filed on Jun. 5, 2006.

(51) Int. Cl. C02F 9/04; A62D 3/38; C02F 1/72

(52) U.S. Cl. 210/721; 252/186.43; 252/186.44; 210/759; 210/758; 210/205; 977/742; 977/750; 977/752; 977/773

(57) ABSTRACT

The present invention is directed to materials for the decontamination of fluids and methods of use thereof. The material and methods find applications in the decontamination of intermediates, chemical contaminants, a biological contaminants, wastewater, industrial effluents, municipal or domestic effluents, agrochemicals, herbicides and/or pharmaceuticals.

### FIELD OF THE INVENTION

The present invention is directed to materials for the decontamination of fluids and methods of use thereof. In which, this invention can find applications in the decontamination of intermediates, chemical contaminants, biological contaminants, wastewater, industrial effluents, municipal or domestic effluents, agrochemicals, herbicides and/or pharmaceuticals and derivatives thereof.

### BACKGROUND OF THE INVENTION

Effective decontamination of solids and fluids remains a technological challenge. Millions of tons of organic chemical compounds, such as organic solvents, petrochemicals, agrochemicals, and pharmaceuticals, are produced each year, by a wide variety of chemical industries, producing highly toxic byproducts, for example, contaminated effluent streams. These effluents should be treated prior to their release back to the environment, since their discharge serves as a source of pollution of soil, sediment, surface and ground water environments. Current treatment methods are severely limited.

Another important consideration is effective decontamination of polluted water. Such decontamination has been conducted via a number of means, for example using the Fenton reaction, which makes use of compositions comprising typically micrometer sized particles containing Iron(II) and hydrogen peroxide, at a pH ranging from 3-6, whereby hydroxyl radicals are generated, as shown in the following equations:

Fe²⁺+H₂O₂------>Fe³⁺+.OH+OH⁻

Fe³⁺+H₂O₂------>Fe²⁺+.OOH+H³⁰

The reactive species generated, in turn, when combined with contaminated fluid, oxidize pollutants in the fluids, at least in part.

While such oxidation has been applied to date, to treat ground water and wastewater, its successful implementation has been problematic, since oxidation occurring in subsurface systems results in poor reaction kinetics, excessive scavenging and excessive non-productive hydrogen peroxide consuming reactions.

Nanoscale iron (Fe⁰) particles have effective reductant and catalytic properties for a wide variety of common environmental contaminants, including chlorinated organic compounds and metal ions. Contaminants such as tetrachloroethane (C₂Cl₄), trichloroethane, dichloroethane, vinylchloride and ethylene which are common solvents can readily accept the electrons from iron oxidation and be reduced to ethane. For halogenated hydrocarbons, almost all can be reduced to benign hydrocarbons by nano-Fe⁰ particles.

Gold (Au⁰) is a very useful catalyst for many chemical reactions. Nanocrystalline gold and oxygen gas have been used to convert unsaturated hydrocarbons to oxygen-containing organic compounds. Such reaction has resulted in the formation of epoxides and ketones; the conversion of carbon monoxide to carbon dioxide; and conversion of cyclohexene, to CO₂, formic acid and oxalic acid, yielding up to 100% conversion.

While oxidative decontamination shows promise, to date the method suffers from poor capture, degradation and/or transformation of waste products and current methods are expensive to implement. With environmental quality standards placing additional demands on industrial producers, viable treatment options as yet remain elusive.

### SUMMARY OF THE INVENTION

In one embodiment, this invention provides a decontaminating fluid comprising a metal nanoparticle and an oxidizing agent, wherein if said nanoparticle is iron oxide, then said oxidizing agent is not O₂ or H₂O₂.

In one embodiment, this invention provides a decontamination kit comprising:
a. an oxidizing agent; and
b. a metal nanoparticle
   wherein if said nanoparticle is iron oxide, then said oxidizing agent is not O₂ or H₂O₂.

In one embodiment, this invention provides a decontaminating method comprising contacting a fluid comprising a contaminant with a nanoparticle comprising a charged metal, wherein said contacting is conducted under aerobic conditions and is for a period of time sufficient to oxidize said contaminant to form a non-toxic compound, thereby decontaminating said fluid.

In one embodiment, this invention provides a decontaminating method comprising contacting a fluid comprising a contaminant with a metal nanoparticle and an oxidizing agent, wherein said contacting is conducted under aerobic conditions and is for a period of time sufficient to oxidize said contaminant to form a non-toxic compound, thereby decontaminating said fluid

In one embodiment, this invention provides a decontamination kit comprising carbon-based: nanoparticles, nanofibers, nano-fullerenes, nanotubes hydrophobic nanoparticles or combination thereof, in an amount sufficient to adsorb up to 100% of a contaminant.

In one embodiment, this invention provides a decontamination device, comprising:
a. an inlet for the introduction of a fluid into said device;
b. a reaction chamber comprising metal nanoparticles;
c. a first channel, which conveys said fluid from said inlet to said reaction chamber;
d. an outlet;
e. a second channel, which conveys said fluid from said reaction chamber to said outlet
   whereby fluid comprising a contaminant is conveyed to said reaction chamber, and contacted with said metal nanoparticles under aerobic conditions for a period of time sufficient to degrade said contaminant, and decontaminated fluid is conveyed from said reaction chamber to said outlet.

In another embodiment, this invention provides a method of decontaminating a fluid, wherein the method comprises applying a fluid comprising a contaminant to a device of this invention.

In another embodiment, this invention provides a decontamination device, comprising:
a. an inlet for the introduction of a fluid into said device;
b. a reaction chamber comprising carbon-based: nanoparticles, nanofibers, nano-fullerenes, nanotubes, hydrophobic nanoparticles or combination thereof;
c. a first channel, which conveys said fluid from said inlet to said reaction chamber;
d. an outlet; and
e. a second channel, which conveys said fluid from said reaction chamber to said outlet
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed thereto, and decontaminated fluid is conveyed from said reaction chamber to said outlet.

In another embodiment, this invention provides a method of decontaminating a fluid, wherein the method comprises applying a fluid comprising a contaminant to the device.

In one embodiment, this invention provides a decontaminating method comprising the steps of:
a. contacting a fluid comprising a contaminant with carbon-based: nanoparticles, nanofibers, nano-fullerenes, nanotubes, hydrophobic nanoparticles or a combination thereof for a period of time sufficient to adsorb said contaminant on at least a part of an exposed surface of said carbon-based: nanoparticles, nanofibers, nano-fullerenes, nanotubes, hydrophobic nanoparticles or combination thereof; and
b. contacting said fluid in (a) with an oxidizing agent and metal nanoparticles,
   whereby said adsorbed contaminant is degraded.

In one embodiment, this invention provides a decontamination device, comprising:

In one embodiment, this invention provides a decontamination device, comprising:
a. an inlet for the introduction of a fluid;
b. an outlet;
c. a first reaction chamber comprising carbon-based: nanoparticles, nanofibers, nano-fullerenes, nanotubes, hydrophobic nanoparticles or combination thereof;
d. a second reaction chamber comprising metal nanoparticles;
e. a first channel, which conveys fluid from said inlet to said first reaction chamber;
f. a second channel, which conveys fluid from said first reaction chamber to said second reaction chamber; and
g. a third channel, which conveys said fluid from said second reaction chamber to said outlet;
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed at least a portion of said contaminant thereto, and fluid is conveyed from said first reaction chamber to said second reaction chamber and contacted with said metal nanoparticles under aerobic conditions for a period of time sufficient to degrade said contaminant, and fluid is conveyed from said reaction chamber to said outlet.

In another embodiment, this invention provides a method of decontaminating a fluid, wherein the method comprises applying a fluid comprising a contaminant to the device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1: Gas chromatography (GC) chromatograms of a diesel fuel solution before adsorption (control), after adsorption on graphite, and after adsorption on multi-wall nanotubes (MWNT).

FIG. 2: GC chromatograms of an anthracene solution before oxidation (control), after oxidation using hydrogen peroxide with TiO₂, Fe₂O₃, CuO, TiC or SiN nanoparticles.

FIG. 3: GC chromatograms of 1,4 dichlorobenzene solution before oxidation (control), after oxidation using hydrogen peroxide with Fe₂O₃, TiC or TiO₂ nanoparticles.

FIG. 4: GC chromatograms of a diesel fuel solution before oxidation (control), after oxidation using hydrogen peroxide with CuO, SiN, TiO₂ or TiC nanoparticles.

FIG. 5: GC chromatograms of a Lindane (hexachlorocyclohexane) solution before oxidation (control), and after oxidation using hydrogen peroxide with TiO₂, Fe₂O₃, TiC or SiN nanoparticles.

FIG. 6: GC chromatograms of a naphthalene solution before adsorption (control), after adsorption on graphite or multi-wall nanotubes (MWNT).

FIG. 7: GC chromatograms of a naphthalene solution before oxidation (control), after oxidation using hydrogen peroxide with TiO₂, Fe₂O₃, TiC, SiN or CuO nanoparticles.

FIG. 8: GC chromatograms of a phenanthrene solution before oxidation (control), after oxidation using hydrogen peroxide with CuO, TiC, SiN or TiO₂ nanoparticles (FIG. 8A). Degradation plot of phenanthrene vs. time using CuO and H₂O₂. (FIG. 8B)

FIG. 9: GC chromatograms of a phenanthrene solution before adsorption (control), after adsorption on graphite or multi-wall nanotubes.

FIG. 10: GC chromatograms of a tribromoneopentyl alcohol solution before oxidation (control), after oxidation using hydrogen peroxide with TiO₂, TiC or iron oxide nanoparticles.

FIG. 11: Schematic plot of decontamination of an acetaminophen solution with Fe₂O₃+H₂O₂, as compared to acetaminophen (control) and acetaminophen+H₂O₂ samples.

FIG. 12: Schematic plot of decontamination of an estradiol solution with Fe₂O₃+H₂O₂ and by adsorption of estradiol on graphite as compared to estradiol+H₂O₂ samples.

FIG. 13: Schematic plot of decontamination of a penicillin G solution with Fe₂O₃+H₂O₂ and by adsorption of penicillin G on graphite as compared to penicillin G (control) and penicillin G+H₂O₂ samples.

FIG. 14A, FIG. 14B, and FIG. 14C: Schematic plot of decontamination of a phenanthrene solution (FIG. 14A), a monochlorobenzene solution (MCB, FIG. 14B) and a dichlorobenzene solution (DCB, FIG. 14C) under aerobic conditions each with TiC, CuO, SiN, TiN and ZnO.

FIG. 15: Schematic depiction of permeable reactive barrier (PRB) continuous wall: an in-ground trench (15-20, 15-30) is backfilled with nanoparticle “filter” (15-20) to provide passive treatment of contaminated ground-water (15-10) passing through the trench. Treatment wall is placed at strategic location to intercept the contaminant plume (15-10) and backfilled with active “filter” (15-20) covered by filling material (15-30), (optional) oxidation agent can be injected through screened well (15-40).

FIG. 16: Schematic depiction of PRB series of wells: In-ground wells (16-20), filled in whole or in part with nanoparticle “filters” (16-30) that direct (funnel) groundwater towards a permeable treatment zone (well/gate) to provide passive treatment of contaminated ground-water (16-10) passing through the wells (16-20). An oxidation agent can optionally be injected into the well (16-40). Treatment wells are placed at strategic locations to intercept the contaminant plume (16-10).

FIG. 17: Schematic depiction of a pumping well with “filter”: this method relies on pumping the contaminated groundwater (17-10) using one or more extraction wells, treating it in each well underground by flowing the water through the active media (17-20) to remove the contaminant(s) and receive clean water (17-30) that can either be further supplied to users or returned to the groundwater without the contaminant(s). (Optional) oxidation agent can be injected into each well (17-40).

FIG. 18: Schematic depiction of above-ground (ex situ) system: This method relies on treating water (ground (18-10) or surface (18-20) water) or effluents (18-30) containing pollutants by flowing the water through an aerobic reactor with active media (18-40) to remove the contaminant(s) and receive clean water (18-50) that can either be further supplied to users or returned to the groundwater without the contaminant(s).

FIG. 19: Schematic depiction of contaminated aqueous solutions: this method relies on treating contaminated aqueous solutions (19-10) by flowing the contaminated solution through an (aerobic) reactor containing nanoparticles (19-20), to remove the contaminant(s) and receive clean solution (19-30) that can be further supplied to users or returned to the subsurface without the contaminant(s). Optional ports (19-40) and (19-50) can optionally allow introduction (or additional introduction of) oxidation agent(s) (19-40) and/or nanoparticles (19-50) into the reaction vessel. Additionally or alternatively, optional ports (19-60) and (19-70) indicate can optionally allow introduction (or additional introduction of) oxidation agent(s) (19-60) and/or nanoparticles (19-70) into the contaminated aqueous solution prior to entry into the reaction vessel.

FIG. 20: Schematic depiction of contaminated aqueous solutions: This method relies on treating contaminated aqueous solutions (20-30) in a holding reservoir by adding the nanoparticles (20-10), and optional oxidation agent (20-20), and thus decontaminating the solution.

FIG. 21: Schematic depiction of gases and vapor treatment: This method relies on treating aerobic vapor and/or gases containing pollutants (21-10) by flowing the contaminated gas phase through an aerobic reactor with active media (21-20), and/bubbled through an aqueous solution, to remove the contaminant(s) and receive clean vapors or gases (21-30) that can be further supplied to users or returned to the atmosphere without the contaminant(s). Additional ports may be added as presented in FIG. 19.

FIG. 22: Degradation plot of alachlor vs. time using CuO and H₂O₂ with or without light.

FIG. 23: Degradation plot of alachlor vs. time using CuO and different concentrations of H₂O₂.

FIG. 24: Degradation plot of alachlor vs. time using CuO and H₂O₂ at different pH conditions.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention provides, in some embodiments, materials and methods for decontaminating, and/or detoxifying fluids and/or concentrating contaminants. In one embodiment, such materials and methods will find application in the treatment of toxic waste products. In another embodiment, such materials and methods will find application in the treatment of effluents resulting from industrial production of various chemical compounds, or pharmaceuticals. In another embodiment, such materials and methods will find application in the treatment of water supplies (rivers, streams, sea water, lake water, groundwater, etc.) contaminated by chemical compounds or toxic materials. In another embodiment, such materials and methods will find application in the treatment of toxic waste products due to occurrence of a natural disaster. In another embodiment, such materials and methods will find application in the treatment of petroleum spills. In another embodiment, such materials and methods will find application in the treatment of process water in the petroleum industry. In another embodiment, such materials and methods will find applications in the treatment of environmental pollutants. In another embodiment, such materials and methods will find application in the decontamination of water. In another embodiment, such materials and methods will find application in the decontamination of chemical reactions. In another embodiment, such materials and methods will find application in the decontamination of organic solvents. In another embodiment, such materials and methods will find application in the decontamination of air. In another embodiment, such materials and methods will find application in the decontamination of gases. In another embodiment, such materials and methods will find application in the decontamination of weapons of mass destruction (W.M.D), or in another embodiment, biological, virus, and/or chemical (including gas and liquid) weapons. In another embodiment, such materials and methods will find application in the decontamination of oil tankers, transport containers, plastic containers or bottles. In another embodiment, such materials and methods will find application in the decontamination of soil. In another embodiment, such materials and methods will find application in the decontamination of filters, for example, air purification and air-conditioning filters.

In one embodiment, this invention provides a decontaminating fluid comprising a metal nanoparticle and an oxidizing agent, wherein if said nanoparticle is iron oxide, then said oxidizing agent is not O₂ or H₂O₂.

In one embodiment, the term “fluid” refers to any material or substance which flows or moves. In one embodiment, the term “fluid” refers to any material or substance which is present in a semisolid, or in another embodiment, liquid, or in another embodiment, sludge, or in another embodiment, slurry, or in another embodiment, vapor, or in another embodiment, gas or in another embodiment, any other form or state, which flows or in another embodiment, moves. In one embodiment the fluids of this invention are aqueous solutions. In another embodiment, the fluids of this invention are gas, or in another embodiment, the fluids of this invention are aqueous solutions bubbled with gas. In another embodiment the fluids of this invention are liquids.

In one embodiment, the term “decontaminating” refers to degrading, eliminating, or isolating, in whole or in part, a substance whose degradation, elimination or isolation is desired. In some embodiments, the term “decontaminating” is to be considered as encompassing the terms “detoxifying” and/or “sanitizing”.

In some embodiments, the material whose decontamination is desired may comprise poisonous, harmful substances, noxious chemicals, undesired pharmaceuticals, toxins, undesirable reaction by-products, pollutants, poisonous gas, or radioactive materials. In some embodiments, the term “decontaminating” refers to the conversion, in whole or in part, of an environmental contaminant to a substance less toxic than the environmental contaminant.

In some embodiments, the decontaminating fluid, kits, devices and/or methods of this invention provide a process by which an environmental contaminant is converted to nontoxic compounds, or, in some embodiments, to compounds less toxic than the environmental contaminant.

In some embodiments, the decontaminating fluid, kits and/or methods of this invention make use of, inter-alia, the process of oxidation, reduction, hydrogenation, dehalogenation (e.g. dechlorination), precipitation, complex formation, adsorption, or any combination thereof, as a means of decontaminating a compound of interest.

In one embodiment, the term “nanoparticle” refers to a microscopic particle, whose size is in the nanometer (nm) range. In one embodiment, the nanoparticles of and for use in this invention possess at least one dimension at a size of less than 1000 nanometers.

In some embodiments, the nanoparticles of and for use in this invention possess specific structural and chemical properties, which vary as a function of their size, which, in some embodiments, will affect reaction kinetics, or in other embodiments, reaction efficiency, etc., for the decontamination processes, as will be appreciated by one skilled in the art.

In some embodiments, the metal nanoparticles of and for use in this invention may comprise, inter-alia, elemental metals (e.g., iron, gold, platinum, nickel, vanadium, titanium); oxides (e.g., iron oxide, titanium oxide, copper oxide, aluminum oxide, zinc oxide); carbides (e.g., titanium carbide); nitrides (e.g., silicon nitride), and combinations thereof.

In one embodiment, the metal nanoparticles of and for use in this invention comprise a charged metal or metals, while the nanoparticle has no overall net charge. In another embodiment, the metal nanoparticle is a charged metal nanoparticle. In another embodiment, the metal nanoparticle is a metal based ionic complex nanoparticle.

In another embodiment, the metal nanoparticles of and for use in this invention are catalytic nanoparticles.

In another embodiment, the metal nanoparticles of and for use in this invention are iron oxide, titanium oxide, titanium carbide, copper oxide, zinc oxide silicon nitride, cerium oxide, zinc sulfide, titanium nitride or any combination thereof. In one embodiment, the metal nanoparticle is comprised of copper oxide. In another embodiment the metal nanoparticle is comprised of iron oxide. In another embodiment the metal nanoparticle is comprised of titanium oxide. In another embodiment the metal nanoparticle is comprised of zinc oxide. In another embodiment the metal nanoparticle is comprised of titanium carbide. In another embodiment the metal nanoparticle is comprised of silicon nitride. In another embodiment the metal nanoparticle is aluminum oxide. In another embodiment the metal nanoparticle is antimony tin oxide. In another embodiment the metal nanoparticle is aluminum titanate. In another embodiment the metal nanoparticle is antimony (III) oxide. In another embodiment the metal nanoparticle is barium ferrite. In another embodiment the metal nanoparticle is barium strontium titanium oxide. In another embodiment the metal nanoparticle is barium titanate (IV). In another embodiment the metal nanoparticle is barium zirconate. In another embodiment the metal nanoparticle is bismuth cobalt zinc oxide. In another embodiment the metal nanoparticle is bismuth (III) oxide. In another embodiment the metal nanoparticle is calcium titanate. In another embodiment the metal nanoparticle is cerium aluminum oxide. In another embodiment the metal nanoparticle is calcium zirconate. In another embodiment the metal nanoparticle is cerium (IV)-zirconium (IV) oxide. In another embodiment the metal nanoparticle is chromium (III) oxide. In another embodiment the metal nanoparticle is cobalt (II,III) oxide. In another embodiment the metal nanoparticle is cobalt aluminum oxide. In another embodiment the metal nanoparticle is copper aluminum oxide. In another embodiment the metal nanoparticle is copper aluminum oxide. In another embodiment the metal nanoparticle is copper (II) oxide. In another embodiment the metal nanoparticle is copper iron oxide. In another embodiment the metal nanoparticle is copper zinc iron oxide. In another embodiment the metal nanoparticle is iron nickel oxide. In another embodiment the metal nanoparticle is nickel zinc iron oxide. In another embodiment the metal nanoparticle is magnesium hydroxide. In another embodiment the metal nanoparticle is magnesium oxide. In another embodiment the metal nanoparticle is manganese (II) titanium oxide. In another embodiment the metal nanoparticle is nickel chromium oxide. In another embodiment the metal nanoparticle is nickel cobalt oxide. In another embodiment the metal nanoparticle is silica nanopowder. In another embodiment the metal nanoparticle is strontium ferrite. In another embodiment the metal nanoparticle is strontium titanate. In another embodiment the metal nanoparticle is tin (IV) oxide. In another embodiment the metal nanoparticle is titanium silicon oxide. In another embodiment the metal nanoparticle is tungsten (VI) oxide. In another embodiment the metal nanoparticle is zinc oxide. In another embodiment the metal nanoparticle is nickel. In another embodiment the metal nanoparticle is platinum. In another embodiment the metal nanoparticle is silver. In another embodiment the metal nanoparticle is silver-copper. In another embodiment the metal nanoparticle is silver platinum. In another embodiment the metal nanoparticle is tin. In another embodiment the metal nanoparticle is zinc. In another embodiment the metal nanoparticle is aluminum nitride. In another embodiment the metal nanoparticle is silicon. In another embodiment the metal nanoparticle is silicon carbide. In another embodiment the metal nanoparticle is silicon nitride. In another embodiment the metal nanoparticle is titanium carbonitride or any combination thereof.

In one embodiment, the metal nanoparticle of and for use in this invention is TiC. In another embodiment TiC in the presence of an oxidizing agent of this invention is partially oxidized to TiO₂. In another embodiment, the metal nanoparticles of and for use in this invention is TiC doped with TiO₂.

In another embodiment, the metal nanoparticle of and for use in this invention comprises a combination of two or more metals. In one embodiment, such combinations comprise two metals at a ratio of about 1:1. In another embodiment such combinations comprise two metals at a ratio of between about 1:1-2:1. In another embodiment, such combinations comprise two metals at a ratio of between about 2:1-5:1. In another embodiment, such combinations comprise two metals at a ratio of between about 5:1-10:1. In another embodiment, such combinations comprise two metals at a ratio of between about 10:1-100:1.

In another embodiment, the metal nanoparticles of and for use in this invention are catalytic nanoparticles, which increase, in some embodiments, the rate of contaminant degradation by reducing the energy barrier for the reaction. In another embodiment, catalytic nanoparticles may be recycled.

In one embodiment, the metal nanoparticles are recovered, or in another embodiment, recycled, or in another embodiment, regenerated and/or further reused after decontamination, using a fluid of this invention, and/or according to the methods of this invention.

In one embodiment, such nanoparticle recovery, reuse, recycle or regeneration may be accomplished by settling, sieving, filtration via, e.g., membranes and/or packed beds, magneto-separation, complexation/sorption, optionally followed by washing of the nanoparticles following their recovery. In one embodiment, the recovery is via centrifugation. In one embodiment, the nanoparticles may be reused multiple times, following recovery from a decontaminating fluid and/or device and/or kit of this invention. In another embodiment, the nanoparticles may be regenerated. In another embodiment the nanoparticles may be regenerated by applying an oxidizing agent to yield the desired oxidation state of the nanoparticles comprising a metal. In another embodiment, the nanoparticles may be regenerated by applying a reducing agent to yield the desired oxidation state of the nanoparticles comprising a metal. In another embodiment, the nanoparticles may be regenerated from a colloidal form, by applying surfactants. In another embodiment, the nanoparticles may be regenerated by isolating the metal product formed in the decontamination fluid, method and/or kit and prepare the desired nanoparticle using the isolated metal.

In one embodiment, the washing of the nanoparticles may be accomplished with water, or any polar solvent.

In another embodiment, the nanoparticles of this invention have a diameter ranging in size from between about 1-50 nm; in another embodiment, the nanoparticles of this invention have a diameter ranging in size from between about 50-150 nm; in another embodiment, the nanoparticles of this invention have a diameter ranging in size from between about 150-300 nm; in another embodiment, the nanoparticles of this invention have a diameter ranging in size from between about 300-500 nm; in another embodiment, the nanoparticles of this invention have a diameter ranging in size from between about 500-700 nm; In another embodiment, the nanoparticles of this invention have a diameter ranging in size from between about 700-1000 nm; in another embodiment, the nanoparticles of this invention have a diameter ranging in size from between about 1-1000 nm.

In one embodiment, the nanoparticles vary in terms of size, or in another embodiment, shape, or in another embodiment, composition, or any combination thereof, within a fluid, kit, device and/or for use according to the methods of this invention. Such differences in the respective nanoparticles used in a particular fluid/kit/device or according to the methods of this invention may be confirmed via electron microscopy, or in another embodiment, by scanning electron microscopy (SEM), or in another embodiment, by tunneling electron microscopy (TEM), or in another embodiment, by optical microscopy, or in another embodiment, by atomic absorption spectroscopy (AAS), or in another embodiment, by X-ray powder diffraction (XRD), or in another embodiment, by X-ray photoelectron spectroscopy (XPS), or in another embodiment, by atomic force microscopy (AFM), or in another embodiment, by ICP (inductively coupled plasma).

In one embodiment, the oxidizing agent employed in the fluids, kits devices and/or methods of this invention is a peroxide. In another embodiment, the oxidizing agent is chromate. In another embodiment, the oxidizing agent is oxygen. In another embodiment, the oxidizing agent is ozone. In another embodiment, the oxidizing agent is chlorate. In another embodiment, the oxidizing agent is perchlorate. In another embodiment, the oxidizing agent is permanganate. In another embodiment, the oxidizing agent is osmium tetraoxide. In another embodiment, the oxidizing agent is bromate. In another embodiment, the oxidizing agent is iodate. In another embodiment the oxidizing agent is chlorite. In another embodiment, the oxidizing agent is hypochlorite. In another embodiment, the oxidizing agent is nitrate. In another embodiment, the oxidizing agent is nitrites. In another embodiment, the oxidizing agent is persulfate. In another embodiment, the oxidizing agent is nitric acid. In another embodiment, the oxidizing agent is an electron acceptor. In another embodiment, the oxidizing agent is hydrogen peroxide. In another embodiment, the oxidizing agent is comprised of combinations of oxidizing agents, for example, two or more oxidizing agents, and in some embodiments, is a combination of the agents described hereinabove.

In one embodiment, when two oxidizing agents are utilized in the liquids, kits, devices and/or methods of this invention, the ratio between the two oxidizing agents, is 1:1, or in another embodiment, 1:1-5:1, or in another embodiment, 5:1-10:1, or in another embodiment, 10:1-100:1. In another embodiment, when two oxidizing agents are utilized wherein one is a gas and the other is a liquid in the fluids, kits, devices and/or methods of this invention, the ratio between the two oxidizing agents, is 100:1-10⁴:1, or in another embodiment, 10⁴:1-10¹⁰:1 or in another embodiment, 10¹⁰:1-10²⁰:1. In another embodiment, when two oxidizing agents are utilized wherein both oxidizing agents are gases in the fluids, kits, devices and/or methods of this invention, the ratio between the two oxidizing agents, is 1:1, or in another embodiment, 1:1-5:1, or in another embodiment, 5:1-10:1, or in another embodiment, 10:1-100:1.

In one embodiment, the oxidizing agent degrades the contaminant to form less toxic and/or non-toxic byproducts. In one embodiment, oxidation via these agents is cyclic, such that byproducts of each round of oxidation, are, in turn, further oxidized until complete degradation to CO₂, H₂O and O₂ and optionally traces of ions, is achieved. In another embodiment, the byproducts are not completely oxidized, but rather represent a desired product for use as a starting material for other purposes, for example, for initiating other chemical reactions.

In one embodiment, the oxidizing agent fully degrades the contaminant to form CO₂, H₂O and trace quantities of ions, which in one embodiment, comprises halogenated ions, which in another embodiment, are chlorinated ions.

The term “electron acceptor” refers, in one embodiment, to a substance that receives electrons in an oxidation-reduction process. Examples of electron acceptors include Fe (III), Mn (IV), oxygen, nitrate, sulfate, Lewis acids, 1,4-dinitrobenzene, or 1,1′-dimethyl-4,4′ bipyridinium.

In another embodiment, decontamination using the fluids, kits or devices of this invention, or according to the methods of this invention, is conducted under aerobic conditions. In one embodiment, employing aerobic conditions entails oxygen functioning as at least one of the oxidizing agents facilitating decontamination. In one embodiment, decontamination using the fluids, kits or devices of this invention or according to the methods of this invention make use of oxygen alone, or in combination with at least one additional oxidizing agent.

In another embodiment, the fluids, kits, devices and/or methods of decontamination of this invention are conducted under ambient environmental conditions. In one embodiment, the term “ambient environmental conditions” refers to conditions present in a natural ecosystem. In another embodiment such conditions refer to temperature, for example, when the desired liquids are found most typically at room temperature, then the ambient environmental conditions present for use of the fluids, kits, devices and/or methods of decontamination of this invention, or in accordance with the methods of this invention, will be conducted at room temperature. In another embodiment, the term “ambient environmental conditions” refers to conditions wherein the contaminated fluid is found in nature, such as, decontaminated fluids found is or arising in seas, oceans, lakes, rivers, grounds, lands, clouds, arctic, desert, ocean floor, etc. In some embodiments, ambient environmental conditions will approximate a particular climate, such as a sea climate, a tropical climate, a desert climate, etc. In some embodiments, ambient environmental conditions will approximate that found with regard to the decontaminated fluid for which decontamination is desired, for example, in the case of contaminated gases being released into the atmosphere, the decontaminating fluids, kits, devices and/or method of this invention for use in decontaminating such air, will be at comparable pressure and temperature as that of the contaminated air. Similarly, contaminated fluids found in, for example, sea water or freshwater supplies, whose decontamination is desired, will make use of fluids, kits, devices and/or according to the methods of this invention, will be conducted at similar conditions, including salt concentration, temperature, etc. as the water supplies whose decontamination is desired.

In another embodiment, the fluids, kits, devices may be used at, or the methods of this invention may be conducted at room temperature. In one embodiment, the methods of this invention may be conducted at a temperature of between about 20-30° C. In one embodiment, the methods of this invention may be conducted at a temperature of between about 30-35° C. In one embodiment, the methods of this invention may be conducted at a temperature of between about 35-40° C. In one embodiment, the methods of this invention may be conducted at a temperature of between about 40-45° C. In one embodiment, the methods of this invention may be conducted at a temperature of between about 45-50° C. In one embodiment, the methods of this invention may be conducted at a temperature of between about 50-60° C. In one embodiment, the methods of this invention may be conducted at a temperature of between about 60-80° C. In one embodiment, the methods of this invention may be conducted at a temperature of between about 20-60° C. In one embodiment, the methods of this invention may be conducted at a temperature of between about 20-80° C. In one embodiment, the methods of this invention may be conducted at a temperature of between about 4-60° C. In one embodiment, the methods of this invention may be conducted at a temperature of between about 0-80° C. In one embodiment, the methods of this invention may be conducted at a temperature above 80° C.

Temperature effects on decontamination were exemplified herein in Example 7 hereinbelow, where the decontamination of naphthalene, using hydrogen peroxide as an oxidizing agent and copper oxide or titanium carbide as metal nanoparticles, resulted in minor differences in degradation at a temperature range between 4-60° C.

In one embodiment, the fluids, kits, devices and/or methods of this invention comprise or make use of a metal nanoparticle, which is comprised of titanium oxide and an oxidizing agent, which is comprised of hydrogen peroxide, O₂, ozone or any combination thereof.

In another embodiment, the fluids, kits devices and/or methods of this invention comprise or make use of a metal nanoparticle, which is comprised of titanium oxide and an oxidizing agent, which is comprised of hydrogen peroxide, O₂, ozone or any combination thereof.

In another embodiment, the fluids, kits devices and/or methods of this invention comprise or make use of a metal nanoparticle, which is comprised of silicon nitride and an oxidizing agent, which is comprised of hydrogen peroxide, O₂, ozone or any combination thereof.

In another embodiment, the fluids, kits, devices and/or methods of this invention comprise or make use of a metal nanoparticle, which is comprised of titanium carbide and an oxidizing agent, which is comprised of hydrogen peroxide, O₂, ozone or any combination thereof.

In another embodiment, the fluids, kits, devices and/or methods of this invention comprise or make use of a metal nanoparticle, which is comprised of copper oxide and an oxidizing agent, which is comprised of hydrogen peroxide, O₂, ozone or any combination thereof. In another embodiment, a metal nanoparticle, which is comprised of zinc oxide and an oxidizing agent, which is comprised of hydrogen peroxide, O₂, ozone or any combination thereof. In another embodiment, a metal nanoparticle, which is comprised of silicon nitride and an oxidizing agent, which is comprised of hydrogen peroxide, O₂, ozone or any combination thereof.

In another embodiment, the fluids, kits, devices and/or methods of this invention comprise and/or make use of an oxidizing agent and a metal nanoparticle in an aqueous solution. In another embodiment, fluids, kits, devices and/or methods of this invention comprise and/or make use of a solution at neutral pH. In another embodiment, the fluids, kits, devices and/or methods of this invention comprise and/or make use of a solution at an acidic pH. In another embodiment, fluids, kits, devices and/or methods of this invention comprise and/or make use of a solution having a pH in the range of about 7-9. In another embodiment, fluids, kits, devices and/or methods of this invention comprise and/or make use of a solution having a pH in the range of about 6-8. In another embodiment, fluids, kits, devices and/or methods of this invention comprise and/or make use of a solution having a pH in the range of about 2-3. In another embodiment, fluids, kits, devices and/or methods of this invention comprise and/or make use of a solution having a pH in the range of about 2-14. In another embodiment, fluids, kits and/or methods of this invention comprise and/or make use of a solution having a pH greater than 8.

In one embodiment, alachlor is decontaminated in aqueous solutions of H₂O₂ and a CuO at a pH range of 2.9-8.6, as exemplified in Example 3, hereinbelow. Fluids and kits/devices comprising such solutions and/or components thereof, respectively as well comprise embodiments of this invention.

In another embodiment, the fluids, kits, devices and/or methods of this invention comprise and/or make use of an aqueous NaCl solution, or, in another embodiment, any other soluble salt. In one embodiment, the salt concentration in such a solution ranges between about 0.0001-10M. In one embodiment, the salt concentration in such a solution ranges between about 0.01 μM-0.1M. In one embodiment, the salt concentration in such a solution ranges between about 0.01-0.5M. In another embodiment, the salt concentration in such a solution ranges between about 0.01-10M. In another embodiment, the salt concentration in such a solution ranges between about 0.1-1M. In another embodiment, the salt concentration in such a solution ranges between about 0.5-1M. In another embodiment, the salt concentration in such a solution ranges between about 1-5M. In another embodiment, the salt concentration in such a solution ranges between about 5-10M.

In one embodiment, the fluids, kits, devices and/or methods of this invention comprise and/or make use of an oxidizing agent at a concentration in said fluid is of between about 0.1-20% v/v. In another embodiment, the oxidizing agent is at a concentration in said fluid is of between about 0-0.1% v/v. In another embodiment, the oxidizing agent is at a concentration in said fluid is of between about 0.1-1% v/v. In another embodiment, the oxidizing agent is at a concentration in said fluid is of between about 1-3% v/v. In another embodiment, the oxidizing agent is at a concentration in said fluid is of between about 3-6% v/v. In another embodiment, the oxidizing agent is at a concentration in said fluid is of between about 6-9% v/v. In another embodiment, the oxidizing agent is at a concentration in said fluid is of between about 9-12% v/v. In another embodiment, the oxidizing agent is at a concentration in said fluid is of between about 12-15% v/v. In another embodiment, the oxidizing agent is at a concentration in said fluid is of between about 15-17% v/v. In another embodiment, the oxidizing agent is at a concentration in said fluid is of between about 17-20% v/v. In another embodiment, the oxidizing agent is at a concentration in said fluid is of between about 20-25% v/v. In another embodiment, the concentrations presented hereinabove relate to non-gases oxidizing agent.

In one embodiment, the fluids, kits, devices and/or methods of this invention comprise and/or make use of a gas phase oxidizing agent comprising O₂ or ozone at a concentration sufficient to degrade and/or oxidize a contaminant up to saturation in said fluid.

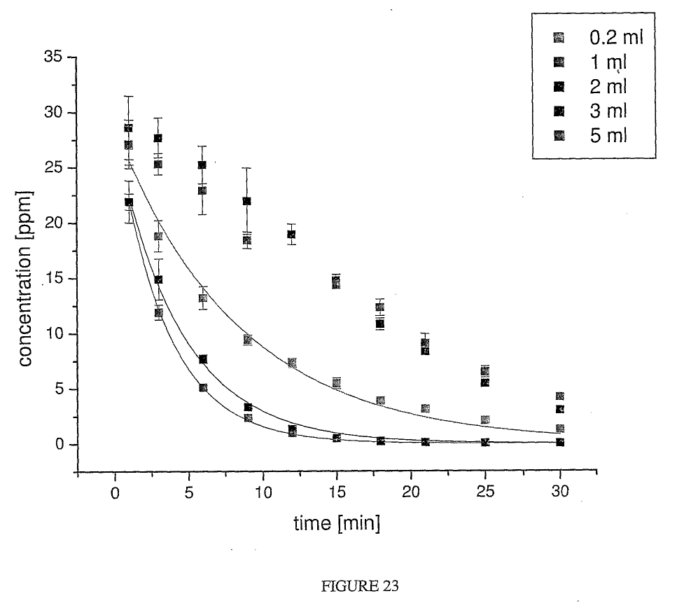

In one embodiment, alachlor is decontaminated in aqueous solutions of CuO and H₂O₂ at varying concentrations of H₂O₂, in some embodiments, as a function of time, as exemplified in FIG. 23 and example 3, hereinbelow. Fluids and kits/devices comprising such solutions and/or components thereof, respectively as well comprise embodiments of this invention.

In one embodiment, the fluids, kits, devices and/or methods of this invention comprise and/or make use of a metal nanoparticle at a concentration of between about 0.001%-1% w/w. In another embodiment, the metal nanoparticle is at a concentration of between about 0.0001%-0.001%. In another embodiment, the metal nanoparticle is at a concentration of between about 0.001%-0.005% w/w. In another embodiment, the metal nanoparticle is at a concentration of between about 0.005%-0.01% w/w. In another embodiment, the metal nanoparticle is at a concentration of between about 0.01%-0.05% w/w. In another embodiment, the metal nanoparticle is at a concentration of between about 0.05%-0.1% w/w. In another embodiment, the metal nanoparticle is at a concentration of between about 0.1%-0.5% w/w. In another embodiment, the metal nanoparticle is at a concentration of between about 0.5%-1% w/w. In another embodiment, the metal nanoparticle is at a concentration of between about 1%-5% w/w.

In one embodiment, the fluids, kits, devices and/or methods of this invention can be used to decontaminate fluids comprising a contaminant at a concentration of between about 0.01 μM-1M. In another embodiment, the contaminant is at a concentration of between about 0.001 μM-0.01 μM. In another embodiment, the contaminant is at a concentration of between about 0.01 μM-0.1 μM. In another embodiment, the contaminant is at a concentration of between about 0.1 μM-1 μM. In another embodiment, the contaminant is at a concentration of between about 1 μM-10 μM. In another embodiment, the contaminant is at a concentration of between about 10 μM-0.1 μM. In another embodiment, the contaminant is at a concentration of between about 0.1M-1M.

In one embodiment, the fluids, kits, devices and/or methods of this invention can be used to decontaminate fluids comprising a contaminant, wherein metal nanoparticles are employed, and decontamination is performed under aerobic conditions, wherein atmospheric oxygen serves as the oxidizing agent, without need of supply of an additional oxidizing agent.

In another embodiment, a fluid contaminated with monochlorobenzene is decontaminated with the aid of silicon nitride nanoparticles, employed under aerobic conditions, with no additional oxidizing agent present, other than atmospheric oxygen.

In another embodiment, a fluid contaminated with monochlorobenzene is decontaminated with the aid of titanium oxide nanoparticles, employed under aerobic conditions, with no additional oxidizing agent present, other than atmospheric oxygen.

In another embodiment, a fluid contaminated with dichlorobenzene is decontaminated with the aid of titanium oxide nanoparticles, employed under aerobic conditions, with no additional oxidizing agent present, other than atmospheric oxygen.

In another embodiment, a fluid contaminated with dichlorobenzene is decontaminated with the aid of silicon nitride nanoparticles, employed under aerobic conditions, with no additional oxidizing agent present, other than atmospheric oxygen.

In another embodiment, a fluid contaminated with phenanthrene is decontaminated with the aid of titanium oxide nanoparticles, employed under aerobic conditions, with no additional oxidizing agent present, other than atmospheric oxygen.

In another embodiment, a fluid contaminated with dichlorobenzene is decontaminated with the aid of silicon nitride nanoparticles, employed under aerobic conditions, with no additional oxidizing agent present, other than atmospheric oxygen.

Fluid decontamination conducted using atmospheric oxygen as the oxidizing agent was exemplified herein in Example 6, where nanoparticles comprising silicon nitride or titanium oxide describe the findings.

In one embodiment, the fluids, kits, devices and/or methods of this invention decontaminate fluids, by contacting the fluid with metal nanoparticles, in the presence of an oxidizing agent, or in another embodiment, under aerobic conditions. In one embodiment, the term “contacting” refers to direct contact, such as, for example, placement of each within a single vesicle or chamber. In one embodiment, the term “contacting” refers to indirect exposure, for example, using a series of relays which convey the fluid and the particles to a chamber or vesicle, or tube, or a means of containment, wherein the two are in contact with each other. In one embodiment, the term “contacting” refers to a process of mixing, or reacting, or agitating, or shaking, or bubbling, etc. In one embodiment, the term “contacting” refers to bubbling or mixing of gases in aqueous solution. In one embodiment, the chamber wherein the two are contacted may comprise a mixer, or agitating stir bar. In one embodiment, magnetic fields are applied in varying orientation, which in turn result in mixing of the magnetic nanoparticles within the fluid. In another embodiment, the term “contacting” refers to indirect mixing, wherein the mixing may be accomplished via conveyance through a series of channels, which result in mixing of the desired fluid. In one embodiment, the term “contacting” refers to direct mixing wherein the contaminated fluid with an oxidizing agent and a metal nanoparticle, is mixed by stirring, stirring with a mechanical stirring, exposing or shaking of such combination. In another embodiment, the term “mixing” is to be understood as encompassing the optional application of a magnetic field, heat, microwaves, ultraviolet light and/or ultrasonic pulses, to accelerate the reaction. In another embodiment, the term “mixing” is to be understood as encompassing the improving of the yield of the process by the application of stirring, shaking and optionally application of a magnetic field, heat, light, microwaves, ultraviolet light and/or ultrasonic pulses.

In one embodiment, such contacting of the metal nanoparticles and oxidizing agent may be conducted prior to contacting with the contaminant. In another embodiment, the oxidizing agent is contacted with the contaminant prior to contacting with the metal nanoparticles. In another embodiment, the oxidizing agent, the nanoparticles and the contaminant are simultaneously mixed.

In one embodiment, the term “about”, refers to a deviance of between 0.0001-5% from the indicated number or range of numbers. In one embodiment, the term “about”, refers to a deviance of between 1-10% from the indicated number or range of numbers. In one embodiment, the term “about”, refers to a deviance of up to 25% from the indicated number or range of numbers.

In one embodiment, the decontaminating fluids and/or kits of this invention may be frozen and stored, for extended periods of time. In one embodiment, the fluids and/or kits may further contain other agents, whose purpose is to preserve activity of the respective components upon thawing.

It is to understood that any embodiment described herein, regarding the fluids of this invention, for example, regarding the choice in oxidizing agent, nanoparticle, or combination thereof, is applicable to the kits, devices and/or methods of this invention, and represent embodiments of this invention.

In one embodiment, this invention provides a decontamination kit comprising:
a. an oxidizing agent
b. a metal nanoparticle
   wherein if said nanoparticle is iron oxide, then said oxidizing agent is not O₂ or H₂O₂.

In one embodiment, the term “kit” refers to a packaged product, which comprises the oxidizing agent and nanoparticle, stored in individual containers, or a single container, at pre-determined ratios and concentration, for use in the decontamination of a specified fluid, for which the use of the kit has been optimized, as will be appreciated by one skilled in the art.

In one embodiment, the choice of oxidizing agent and/or nanoparticle composition will depend upon the indicated use for decontaminating a particular compound, for example, for fluids comprising hydrocarbon-based fuel contaminants, effluents formed as a result of a particular chemical process, pharmaceutical process, etc.

In one embodiment, the kit will contain instructions for a range of uses of the individual components, which may be present in the kit at various concentrations and/or ratios, in individually marked containers, whereby the end-user is provided optimized instructions for use in a particular application.

In one embodiment, the kits are comprised of agents whose composition and/or concentration are optimized for the types of contaminants for which the kits will be put to use, for example, for various hydrocarbon-contaminated fluids. In another embodiment, the kits are comprised of agents whose composition and/or concentration are optimized for use in a particular environment, for example, for the decontamination of a water supply adjacent to chemical factories, which produce various solvents or toxins.

In one embodiment, the kits comprise oxidizing agents and nanoparticles in individual containers, and the kit may be stored for prolonged periods of time at room temperature. In one embodiment, the kits of this invention may comprise oxidizing agents and nanoparticles in a single container, with the components segregated within the container, such that immediately prior to use, the individual components are mixed and ready for use. In one embodiment, such segregation may be accomplished via the use of impairment membrane which may be ruptured or compromised by the application of force or a tool specific for such rupture. In one embodiment, such kits may be stored for prolonged periods of time at room temperature.

In one embodiment, the kits of this invention may comprise oxidizing agents and nanoparticles in a single container, in a mixture, as a fluid. In one embodiment, such kits may be stored frozen for prolonged periods of time and upon thawing are ready-to-use.

In one embodiment, the kits may additionally comprise an indicator compound, which reflects partial or complete degradation of the contaminant.

In one embodiment, this invention provides a decontaminating method comprising contacting a fluid comprising a contaminant with a nanoparticle comprising charged metal, wherein said contacting is conducted under aerobic conditions and is for a period of time sufficient to oxidize said contaminant to form a less toxic and/or non-toxic compound, thereby decontaminating said fluid.

In one embodiment, this invention provides a decontaminating method comprising contacting a fluid comprising a contaminant with a metal nanoparticle and an oxidizing agent, wherein said contacting is conducted under aerobic conditions and is for a period of time sufficient to oxidize said contaminant to form a less toxic and/or non-toxic compound, thereby decontaminating said fluid.

In one embodiment, the fluids, kits, devices and/or methods of this invention are employed for the detoxification and/or decontamination of fluids comprising, inter-alia, a chemical contaminant, a biological contaminant, a wastewater, a hydrocarbon, an industrial effluent, a municipal or domestic effluent, an industrial solvent, a petrochemical, sulfur containing effluents, a metal, an agrochemical, an herbicide, a pharmaceutical, a volatile organic hydrocarbon, a vapor, a gas, a weapon of mass destruction or any combination thereof.

In one embodiment, the terms “a” or “an” as used herein, refer to at least one, or multiples of the indicated element, which may be present in any desired order of magnitude, to suit a particular application, as will be appreciated by the skilled artisan. In one embodiment, the term “a nanoparticle” refers to two or more kinds of nanoparticles, which differ in terms of their composition, or in one embodiment, size, or in one embodiment, surface modification, or a combination thereof, or other qualitative differences as will be understood by one skilled in the art. In some embodiments, the fluids, kits and methods of this invention may comprise and/or make use of multiple kinds of nanoparticles for decontaminating a fluid comprising multiple contaminants, in one embodiment, or a single contaminant, in another embodiment.

Similarly, the terms “a” or “an” as used herein, when in reference to an oxidizing agent in a fluid, kit or for use in a method of this invention, refer to at least one, or 2 or more oxidizing agents, or multiples of oxidizing agents, whose choice may be a function of, in one embodiment, the type of contaminant, or in another embodiment, the quantity of contaminant present in the fluid, the concentration of the contaminant, and the volume of the contaminant.

In one embodiment, the fluids, kits, devices and/or methods of this invention are for use in decontaminating a fluid comprising the contaminant monochlorobenzene, wherein the metal nanoparticle employed is TiC and the oxidizing agent employed is hydrogen peroxide.

In one embodiment, the fluids, kits, devices and/or method of this invention are for use in decontaminating a fluid comprising the contaminant monochlorobenzene, wherein the charged-metal nanoparticle is TiO₂ and the oxidizing agent is hydrogen peroxide.

In one embodiment, the fluids, kits, devices and/or method of this invention are for use in decontaminating a fluid comprising the contaminant dichlorobenzene, wherein the charged-metal nanoparticle is TiC and the oxidizing agent is hydrogen peroxide.

In one embodiment, the fluids, kits, devices and/or method of this invention are for use in decontaminating a fluid comprising the contaminant dichlorobenzene, wherein the charged-metal nanoparticle is TiO₂ and the oxidizing agent is hydrogen peroxide.

Monochlorobenzene is used mainly as a solvent in pesticide formulations, as a degreasing agent and as an intermediate in the synthesis of other halogenated organic compounds. Chlorobenzenes are used mainly as process solvents and solvent carriers as well as compounds in the synthesis of pesticides (mainly), plastics, dyes, pharmaceuticals and other organic compounds. They are used as insecticidal fumigants against moths, as space deodorizers, as general insecticides and fungicides on crops. They are used in metal treatments; in industrial deodorants; in cleaners for drains. These compounds are known persistent water contaminants and are common in industrial sites around the world. In one embodiment, the fluids, kits and/or methods may be applied for the decontamination of any fluid comprising a chlorobenzene, regardless of the means by which the fluid became contaminated with a chlorobenzene.

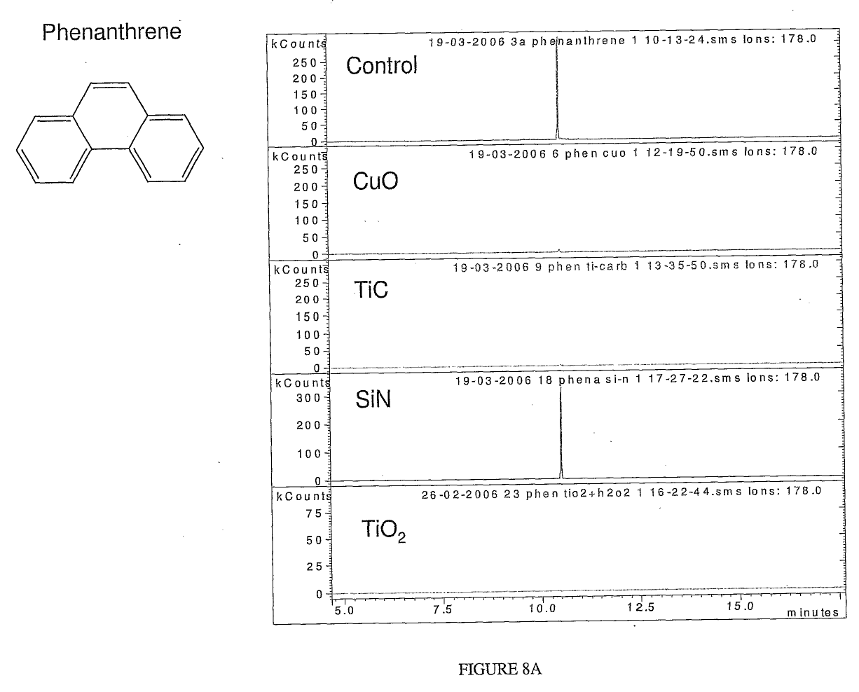

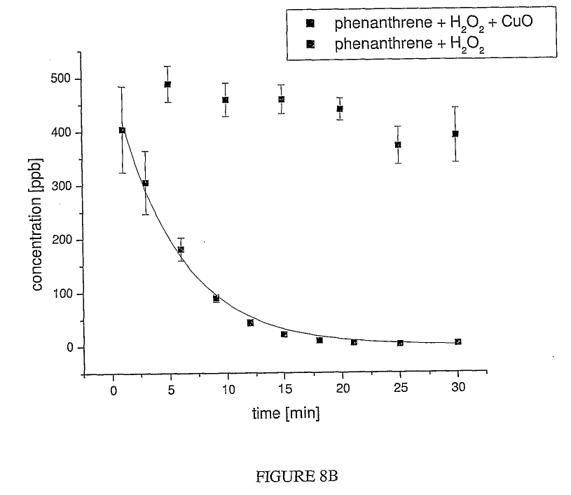

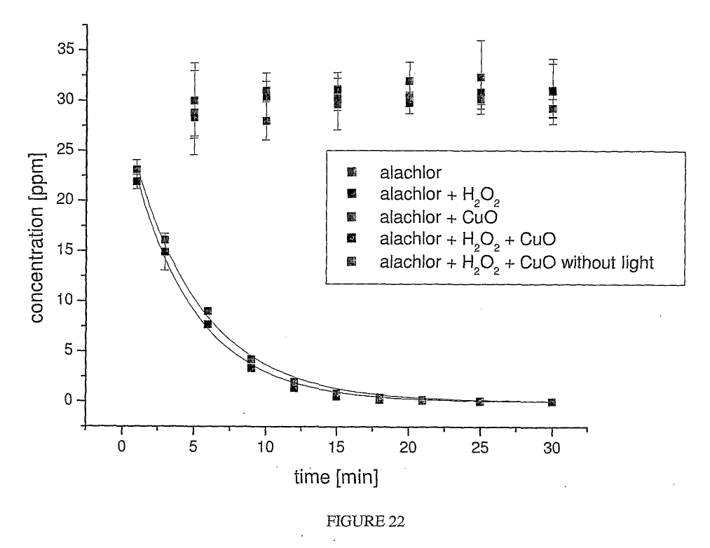

Some embodiments of decontamination methods and fluids of this invention are exemplified herein in Examples 1-4 and Example 6, which serve as guidance for one of skill in the art to practice this invention, which as will be appreciated, may comprise other variations of such methods and fluids, and be within the scope of this invention. According to this aspect, and as exemplified herein, essentially complete degradation of the contaminant was accomplished within 72 hours. In one embodiment, the degradation of phenanthrene using CuO and H₂O₂ follows a first order kinetics with a time constant of 5.45±0.26 minutes as exemplified in Example 3 and depicted in FIG. 8B. In another embodiment, the degradation of alachlor using CuO and H₂O₂ follows a first order kinetics with a time constant of 4.46±0.17 minutes (light) and 4.88±0.168 minutes (no light) as exemplified in Example 3 and depicted in FIG. 22.

In some embodiments, the decontamination methods of this invention may be conducted over a course of a few seconds, or in some embodiments minutes or in some embodiments hours, or in some embodiments, days, or in some embodiments, weeks, wherein the conducting of the method over time enables a greater percentage of complete degradation of the contaminant, in some embodiments, or a greater conversion of a contaminant to one, or several less toxic and/or non-toxic by-products, in another embodiment.

In one embodiment, the period of time sufficient to degrade and/or convert the contaminant ranges from between about 1-10 seconds. In another embodiment, the period of time sufficient to degrade and/or convert the contaminant ranges from between about 10-30 sec. In another embodiment, the period of time sufficient to degrade and/or convert the contaminant ranges from between about 30-60 sec. In another embodiment, the period of time sufficient to degrade and/or convert the contaminant ranges from between about 1-5 minutes. In another embodiment, the period of time sufficient to degrade and/or convert the contaminant ranges from between about 5-15 minutes. In another embodiment, the period of time sufficient to degrade and/or convert the contaminant ranges from between about 15-30 minutes. In another embodiment, the period of time sufficient to degrade and/or convert the contaminant ranges from between about 15-60 minutes. In another embodiment, the period of time sufficient to degrade and/or convert the contaminant ranges from between about 1-5 hours. In another embodiment, the period of time sufficient to degrade and/or convert the contaminant ranges from between about 5-10 hours. In another embodiment, the period of time sufficient to degrade and/or convert the contaminant ranges from between about 10-24 hours. In another embodiment, the period of time sufficient to degrade and/or convert the contaminant ranges from between about 24-48 hours. In another embodiment, the period of time sufficient to degrade and/or convert the contaminant ranges from between about 48-72 hours. In another embodiment, the period of time sufficient to degrade and/or convert the contaminant ranges from between about 72-96 hours. In another embodiment, the period of time sufficient to degrade and/or convert the contaminant ranges from between about a week-10 days.

In one embodiment, the degradation of the contaminant is about 100%. In another embodiment, the degradation of the contaminant is between about 90-100%. In another embodiment, the degradation of the contaminant is between about 80-100%. In another embodiment, the degradation of the contaminant is between about 50-100%. In another embodiment, the degradation of the contaminant is between about 50-70%.

In one embodiment, the conversion of the contaminant to less toxic and/or non-toxic by-products is about 100%. In another embodiment, the conversion of the contaminant to less toxic and/or non-toxic by-products is between about 90-100%. In another embodiment, the conversion of the contaminant to less toxic and/or non-toxic by-products is between about 80-100%. In another embodiment, the conversion of the contaminant to less toxic and/or non-toxic by-products is between about 50-100%. In another embodiment, the conversion of the contaminant to less toxic and/or non-toxic by-products is between about 50-70%.

In one embodiment, the efficiency of conversion and/or decontamination of a fluid using the fluids, kits, devices and/or according to the methods of this invention, will be a function of the choice in nanoparticle, or in some embodiments, oxidizing agent, or in some embodiments, the concentration of the nanoparticle and/or oxidizing agent relative to the contaminant, the environmental conditions present, etc. as will be appreciated by one skilled in the art. In one embodiment, the term “efficiency” refers to the percent complete decontamination, or in another embodiment, percent conversion to non-toxic, or less toxic materials. In one embodiment, the term “efficiency” refers to the amount of time needed to effect such decontamination.

In another embodiment, the term “decontamination” or “decontaminating” refers to degradation, conversion, or a combination thereof of the contaminant to less toxic and/or non-toxic byproducts. In one embodiment, the combined degradation and conversion activity will be at about 100%. In another embodiment, the combined activity will be about 90-100%. In another embodiment, the combined activity will be about 80-100%. In another embodiment, the combined activity will be about 50-100%. In another embodiment, the combined activity will be about 50-70%.

In one embodiment the end-products of the decontamination method are H₂O, CO₂, and O₂ and may comprise trace quantities of ions. In another embodiment, the end-products of the decontamination are H₂O, CO₂, O₂, and may comprise trace quantities of various ions and contaminant byproducts.

In another embodiment, the percent of degradation and/or conversion to less toxic byproducts of the contaminant may be a function of, in one embodiment, the type of contaminant, or in another embodiment, the type of nanoparticle, or in another embodiment, the oxidizer concentration, or in another embodiment, the concentration ratio between the contaminant and the oxidizer, or in another embodiment, the concentration ratio between the nanoparticles, contaminant and oxidizer, or in another embodiment, the concentration ratio between the contaminant and the nanoparticles, or in another embodiment a function of the temperature, or in another embodiment a function of the salt concentration of the fluid, or in another embodiment a function of the pH, or in another embodiment a function of the time, or in another embodiment a function of other compounds in the fluid, or any combination thereof.

The fluids, devices kits and/or methods of this invention provide, in one embodiment for the complete, or, in another embodiment, partial degradation of the contaminant to small molecules, such as CO₂, H₂O, O₂ and trace quantities of ions, or in another embodiment, the complete, or partial conversion of the contaminant to a less-toxic and/or non-toxic compound. Such degradation and/or conversion can be ascertained by a number of means well known in the art, including, inter-alia, analysis of the fluid for detection and/or quantification of any remaining contaminant at the conclusion of the decontamination process. Such detection may be accomplished via the use of mass spectroscopy (MS) techniques or optical means such as absorbance measurement using ultraviolet or visible light absorbance (UV-VIS), or infrared (IR) absorbance measurements, gas chromatograph (GC), High Performance Liquid Chromatography (HPLC), titration, elemental analysis, absorbable organic halogens (AOX), total organic carbon (TOC), biological oxygen demand (BOD), chemical oxygen demand (COD), nuclear magnetic resonance (NMR), and/or chromatographic methods may be employed as well.

In some embodiments, the detection may be employed for quantification and/or detection of specific byproducts formed during the decontamination process. In some embodiments, the detection may be employed for quantification and/or detection of gas formed or evolved during the decontamination process, which in one embodiment, is detected by chromatographic techniques.

In one embodiment, this invention provides a decontamination device, comprising:
a. an inlet for the introduction of a fluid into said device;
b. a reaction chamber comprising metal nanoparticles;
c. a first channel, which conveys said fluid from said inlet to said reaction chamber;
d. an outlet;
e. a second channel, which conveys said fluid from said reaction chamber to said outlet;
   whereby fluid comprising a contaminant is conveyed to said reaction chamber and contacted with said metal nanoparticles under aerobic conditions for a period of time sufficient to degrade said contaminant, and decontaminated fluid is conveyed from said reaction chamber to said outlet.

In one embodiment, the devices of the invention may comprise multiple inlets for introduction of an oxidizing agent, nanoparticles and/or air. In some embodiments, the device will comprise a series of channels for the conveyance of the respective contaminated fluid, oxidizing agent, and other materials, to the reaction chamber. In some embodiments, such channels will be so constructed so as to promote contact between the introduced materials, should this be a desired application. In some embodiments, the device will comprise micro- or nano-fluidic pumps to facilitate conveyance and/or contacting of the materials for introduction into the reaction chamber.

In another embodiment the devices of this invention may comprise a stirrer in the device, for example, in the reaction chamber. In another embodiment, the device may be fitted to an apparatus which mechanically mixes the materials, for example, via sonication, in one embodiment, or via application of magnetic fields in multiple orientations, which in some embodiments, causes the movement and subsequent mixing of the magnetic particles. It will be understood by the skilled artisan that the devices of this invention are, in some embodiments, designed modularly to accommodate a variety of mixing machinery or implements and are to be considered as part of this invention.

In one embodiment the oxidizing agent is conveyed directly to the reaction chamber, such that it does not come into contact with the contaminated fluid, prior to entry within the chamber, in the presence of the nanoparticles. In one embodiment, such conveyance is via the presence of multiple separate chambers or channels within the device, conveying individual materials to the chamber. In another embodiment, the chambers/channels are so constructed so as to allow for mixing of the components at a desired time and circumstance.

In one embodiment, the devices may further include a separated channel for conveying the fluid to the reaction chamber.

In one embodiment, the devices may further include additional means to apply environmental controls, such as temperature, pressure and/or pH. In one embodiment, the device of the invention may include a magnetic field source and mixer to permit magnetically-controlled fluidizing. In another embodiment, the devices may include a mechanical stirrer, a heating, a light, a microwave, an ultraviolet and/or an ultrasonic source. In one embodiment, the device of the invention may include gas bubbling.

In one embodiment, this invention provides a method of decontamination of a fluid, the method comprising the step of applying a fluid comprising a contaminant to a decontamination device, said device comprising:
a. an inlet for the introduction of a fluid into said device;
b. a reaction chamber comprising metal nanoparticles;
c. a first channel, which conveys said fluid from said inlet to said reaction chamber;
d. an outlet; and
e. a second channel, which conveys said fluid from said reaction chamber to said outlet
   whereby fluid comprising a contaminant is conveyed to said reaction chamber and contacted with said metal nanoparticles under aerobic conditions for a period of time sufficient to degrade said contaminant, and decontaminated fluid is conveyed from said reaction chamber to said outlet.

In another embodiment, the fluid is introduced into a reaction chamber, comprising pre-contacted metal nanoparticles and oxidizing agent. In another embodiment, an oxidizing agent is first contacted with a contaminated fluid and further introduced into the reaction chamber of a decontamination device of this invention.

In another embodiment, the reaction chamber is a column. In another embodiment, the reaction chamber is a tube or tubing. In one embodiment, the reaction chamber comprises an enclosure for metal nanoparticles immobilized on a solid support.

In one embodiment the fluids, devices, kits and/or methods of this invention provide metal nanoparticles immobilized on a solid support.

In one embodiment, the metal nanoparticles are immobilized covalently on, chemisorbed on, or physisorbed to a solid support.

In one embodiment, the nanoparticles are adsorbed to the surface of a solid support via hydrogen bonding. In another embodiment, the nanoparticles are adsorbed to the surface of a solid support via hydrophobic interaction. In another embodiment, the nanoparticles are adsorbed to the surface of a solid support via covalent interaction.

In another embodiment, the nanoparticles are adsorbed to the surface of the solid support by drop casting. In another embodiment, the nanoparticles are adsorbed by wet chemical deposition. In another embodiment, the nanoparticles are adsorbed by suspension deposition. In another embodiment, the nanoparticles are adsorbed by spray coating. In another embodiment, the nanoparticles are adsorbed by MOCVD (metal organic chemical vapor deposition).

Drop Casting films are obtained by placement of a droplet of the nanoparticle suspension on a solid surface and subsequent solvent evaporation.

MOCVD is method of creating controllable epi-taxial layered structures by atomic deposition over a substrate material. A substrate wafer is placed on graphite and heated in a reaction vessel. The nanoparticles are grown in a hydrogen-rich atmosphere and subsequently form epi-taxial layers on the substrate.

Wet chemical deposition includes the use of a liquid as a carrier for the metal based nanoparticles, in which the surface is immersed for a period of time to allow physisorbed or chemisorbed adsorption.

Spray coating which includes the use of pressure device able to distribute the nanoparticles on a surface, using a liquid or a gas as a carrier material or combination thereof, in which the substrate is immersed for a period of time to allow physisorption or chemisorption.

In another embodiment, the nanoparticles are adsorbed to the surface of the solid support, via formation of the particles directly on the surface, or inside a cavity of a porous material, which then is used as the solid support in the devices and/or methods of this invention.

In one embodiment, the metal nanoparticles are embedded in a porous material. In one embodiment, the metal nanoparticles are trapped in a porous material. In one embodiment, the metal nanoparticles are encapsulated in a porous material.

In one embodiment the porous material is a zeolite, a clay, a diatomite, a nanotube, dendrimers or other natural materials and minerals. In another embodiment, the porous material is a macroporous material.

In one embodiment, macroporous materials for use in the devices and/or methods of this invention will have a pore diameter of >500 Å.

In one embodiment, the porous materials for use in the devices and/or methods of this invention are mesoporous materials. In another embodiment, the mesoporous materials have a pore diameter of between 20-500 Å.

In one embodiment the porous materials for use in the devices and/or methods of this invention are microporous materials. In another embodiment the microporous materials have a pore diameter <2 mm.

In one embodiment, the porous materials for use in the devices and/or methods of this invention are materials of nano-scale size. In one embodiment, the nanoporous materials have a pore diameter of 1-100 Å.

The term “diameter”, in some embodiments, refers to its ordinary meaning. In some embodiments, the term “diameter” refers to a measure of the effective size of particulate matter, independent of its shape, and its inquiry into the ability of a molecule to permeate its interstitial space. For example a molecule such as a nanotube, is substantially non-spherical, and in some embodiments, the term “diameter” will refer to its pore size. In some embodiments, the effective diameter can be determined by optical or electron microscopy for the particular material in question.

In one embodiment, the porous materials which comprise the devices and are used in the methods of this invention may be those employed in ion exchange, separation, catalyst, sensor, biological molecular isolation, purification, and adsorption processes, well known in the art. In one embodiment the porous materials have open pores. In another embodiment, the pores have various shapes and morphology such as cylindrical, spherical, and slit type pores. In some embodiments, pores are straight or curved or with many turns and twists, thus having a high tortuosity.

In one embodiment, the solid supports of this invention are loaded or adsorbed with nanoparticles, including any embodiment described herein, or combinations thereof.

In some embodiments, nanoparticles of a single size, shape and/or type, are immobilized onto particles of another type. For example, and in one embodiment, titanium oxide (TiO₂) nanoparticles may be immobilized on gold particles and packed in a column, and a fluid comprising a contaminant and H₂O₂ is introduced to the device via an inlet of the device.

In one embodiment, the decontaminating devices of this invention comprise well-packed nanoparticles in a reaction chamber. In another embodiment, the term “well-packed” refers to the nanoparticles which are filled closely, loaded or in high density in the reaction chamber.

In one embodiment, a fluid comprising a contaminant and H₂O₂ is introduced to a device of this invention comprising a column comprising titanium carbide (TiC) nanoparticles.

In one embodiment, a fluid comprising a contaminant and H₂O₂ is introduced to a device of this invention comprising a column comprising titanium oxide (TiO₂) nanoparticles embedded in a zeolite.

In one embodiment, a fluid comprising a contaminant and H₂O₂ is introduced to a device of this invention comprising a column comprising titanium carbide (TiC) nanoparticles embedded in a zeolite.

In one embodiment, a fluid comprising a contaminant and H₂O₂ is introduced to a device of this invention. According to this aspect, and in one embodiment, the device will comprise a column comprising copper oxide (CuO) nanoparticles embedded in a zeolite.

In another embodiment, the devices of this invention are so constructed so as to accommodate introduction of a contaminated fluid, which is an aqueous solution, or in another embodiment, a gas, or in another embodiment, a liquid, which in some embodiments is viscous.

In another embodiment the devices of this invention are so as to allow the introduction of the oxidizer separately from the contaminant. In another embodiment, the device is so constructed so as to allow pre-contacting of the oxidizer and the contaminant prior to contacting with the nanoparticles.

In another embodiment the devices of this invention are so constructed so as to be able to accommodate fluids with varying temperature, pressure, pH, or salt conditions.

In another embodiment, the devices of this invention are so constructed so as to be able to control the pH of the fluid. In another embodiment, the device is so constructed so as to be able to alter the pH of the fluid. In another embodiment the device is so constructed so as to be able to control the temperature of the fluid. In another embodiment the device is so constructed so as to be able to alter the temperature of the fluid.

In some embodiments, the devices comprise ports or valves through which pressure may be applied, or in other embodiments, fluids may be applied under a particular pressure. In one embodiment, the fluid introduced into the device is under a 1 atm applied pressure. In one embodiment, the fluid introduced into the device is under a 1-10 atm applied pressure. In one embodiment, the fluid introduced into the device under a 10-20 atm applied pressure. In one embodiment, the fluid introduced into the device is under a 20-30 atm pressure. In one embodiment, the fluid introduced into the device is under a 30-40 atm pressure. In one embodiment, the fluid introduced into the device is under a 40-50 atm pressure. In one embodiment, the fluid introduced into the device is under a 50-100 atm pressure.

In one embodiment, the devices comprises a relay system such that fluid which has undergone one round of decontamination may be re-applied to the device, to undergo one or more successive decontamination cycles, which, in turn may, in one embodiment, render the decontamination process more efficient, in terms of the percent material fully degraded, in some embodiments, or quantity of contaminant converted and/or degraded to various by-products, in another embodiment.

It is to be understood that the fluids, kits and/or devices of this invention comprise nanoparticles, which may be concentrated, isolated, etc. and recovered, and reused in subsequent applications. Such recovery and reuse will be readily understood to one of skill in the art, and may include, for example, the application of a magnet and subsequent isolation, or placement of a semipermeable barrier between the region whereby the fluid is mixed with nanoparticles and decontaminated, and the subsequent decontaminated fluid is conveyed, while particles are prevented from conveyance and may be concentrated and isolated.

In one embodiment this invention provides fluids, kits, devices and/or methods for decontaminating, detoxifying fluids and/or concentrating such materials, via the adsorption, at least in part of the contaminant to a carbon-based: nanoparticle, nanofiber, nano-fullerene, nanotube, hydrophobic nanoparticle or combination thereof.

In one embodiment, the nanoparticles may be converted to other reactive species when in contact with an oxidizing agent, and representing an embodiment of the invention.

In one embodiment, the adsorption may be accomplished under aerobic conditions, or in another embodiment, anaerobic conditions. In one embodiment, the adsorption may be accomplished under reducing conditions.

In one embodiment, this invention provides a decontamination kit comprising: carbon-based: nanoparticles, nanofibers, nano-fullerenes, nanotubes, hydrophobic nanoparticles or combination thereof in an amount sufficient to adsorb up to 100% of a contaminant.

In one embodiment, any kit of this invention may comprise any embodiment as described herein, and is to be considered as part of this invention. In some embodiments, the kits of this invention will provide instructions for optimized use for particular contaminants, or concentrations thereof, etc.

In some embodiments, this invention provides a decontaminating kit for, detoxifying fluids and/or concentrating such materials. In one embodiment, such a kit will find application in, inter-alia, treatment of toxic waste products, treatment of effluents from industrial production of chemical compounds, or pharmaceuticals, treatment of water (rivers, streams, sea water, lake water, groundwater, etc.) contaminated by chemical compounds or toxic materials, treatment of toxic waste products due to a natural disaster problems, treatment of petroleum spills, treatment of environmental pollutants, decontaminating water, decontaminating chemical reactions, decontaminating organic solvents, decontaminating air, decontaminating gases in decontaminating weapons of mass destruction (W.M.D), including biological, virus, and chemical (including gas and liquid) weapons decontaminating oil tankers, transport containers, plastic containers or bottles, decontaminating soil, decontaminating air-conditioning filters.

In another embodiment, the kit further comprises an oxidizing agent. In another embodiment, the oxidizing agent may comprise any embodiment as described herein, or combinations thereof.

In one embodiment, “carbon-based: nanoparticles, nanofibers, nano-fullerenes, nanotubes hydrophobic nanoparticles or combination thereof” refer to nanoparticles, nanofibers, nano-fullerenes, nanotubes hydrophobic nanoparticles comprising substituted or unsubstituted saturated and/or unsaturated hydrocarbons. In another embodiment, the hydrocarbons are substituted, for example by halogens, haloalkyls, cyano, nitro, amino, alkylamino, amido, carboxylic acid, aldehydes groups, or any combination thereof. In another embodiment, the saturated or unsaturated hydrocarbons are cyclic and optionally comprise a heteroatom.

In one embodiment “carbon-based: nanoparticles, nanofibers, nano-fullerenes, nanotubes hydrophobic nanoparticles or combination thereof” refer to nanoparticles, nanofibers, nano-fullerenes, nanotubes hydrophobic nanoparticles comprising graphite.

In one embodiment “carbon-based: nanoparticles, nanofibers, nano-fullerenes, nanotubes hydrophobic nanoparticles or combination thereof” refer to nanoparticles, nanofibers, nano-fullerenes, nanotubes hydrophobic nanoparticles comprising hybrids of hydrocarbons or graphite with metals. In another embodiment, the metals are, for example, tungsten, cadmium, gold, titanium, nickel, cobalt, copper, iron, palladium, platinum, silver or any combination thereof.

Fullerenes are molecules composed entirely of carbon, in the form of a hollow sphere, ellipsoid, tube or other derivatives thereof. Spherical fullerenes are sometimes called buckyballs. Fullerenes are similar in structure to graphite, which is composed of a sheet of linked hexagonal rings, but they contain pentagonal (or sometimes heptagonal) rings that prevent the sheet from being planar.

Nanotubes are cylindrical fullerenes. These tubes of carbon are usually only a few nanometres wide, but they can range from less than a micrometer to a full meter in length. In another embodiment, the nanotubes of this invention are single-walled carbon nanotubes. In another embodiment, the nanotubes are multi-walled carbon nanotubes. In another embodiment, the nanotubes possess an armchair structure. In another embodiment, the nanotubes possess a zig zag structure. In another embodiment, the nanotube is chiral.

In one embodiment, the nanofibers of this invention are graphite nanofibers. In another embodiment, the nanofibers are carbon nanofibers. In another embodiment, the nanofibers are polymeric nanofibers.

In one embodiment, the carbon-based nanoparticles are graphite based nanoparticles. In another embodiment, the carbon-based nanoparticles of this invention have a diameter ranging from between about 1-50 nm; In another embodiment, the carbon-based nanoparticles have a diameter ranging from between about of 50-150 nm; In another embodiment, the carbon-based nanoparticles have a diameter ranging from between about 150-300 nm; In another embodiment, the carbon-based nanoparticles have a diameter ranging from between about 300-500 nm; In another embodiment, the carbon-based nanoparticles have a diameter ranging from between about 500-700 nm; In another embodiment, the carbon-based nanoparticles have a diameter ranging from between about 700-1000 nm; In another embodiment, the carbon-based nanoparticles have a diameter ranging from between about 1-1000 nm.

The term “hydrophobic nanoparticle” refers to nanoparticles with hydrophobic surface, wherein nanoparticles such as glass, silicon, metal, semiconductor, are coated by hydrophobic material such as hydrophobic polymers, or long aliphatic chains of 8-18 carbons. The hydrophobic material may be chemisorbed, covalently or physisorbed on the nanoparticle.

In another embodiment, the hydrophobic nanoparticles have a diameter size ranging from between about 10-1,000 nm, in at least one dimension. In another embodiment, the hydrophobic nanoparticles have a diameter size ranging from between about 10-100 nm, in at least one dimension. In another embodiment, the hydrophobic nanoparticles have a diameter size ranging from between about 100-400 nm, in at least one dimension. In another embodiment, the hydrophobic nanoparticles have a diameter size ranging from between about 400-600 nm, in at least one dimension. In another embodiment, the hydrophobic nanoparticles have a diameter size ranging from between about 600-1,000 nm, in at least one dimension.

In one embodiment, upon adsorption of a contaminant to carbon-based: nanoparticles, nanofibers, nano-fullerenes, nanotubes or to hydrophobic nanoparticles, the adsorbed system is subsequently contacted with an oxidizing agent, and further degradation of the contaminant is accomplished.

In another embodiment, the adsorbed contaminant on the nano-material is isolated by filtration or centrifugation.

In one embodiment the isolated adsorbed contaminant on the nano-material may be burned, and thereby represents a fuel source.

In another embodiment, the isolated adsorbed contaminant is further oxidized, with an oxidizing agent, resulting in degradation of the contaminant to CO₂, H₂O, O₂ and optionally traces of ions. In another embodiment, the isolated adsorbed contaminant is further oxidized, with an oxidizing agent, resulting in degradation and/or conversion of the contaminant to less toxic and/or non-toxic byproducts.

In another embodiment, the contaminant is de-adsorbed, or stripped of from carbon-based: nanoparticles, nanofibers, nano-fullerenes, nanotubes or the hydrophobic nanoparticles. Such de-adsorption and/or stripping may be accomplished thermally, through the application of microwaves, photochemically and/or by stirring and shaking means. In another embodiment, such de-adsorption and/or stripping may be accomplished by using acids and/or solvents.

In another embodiment, the de-adsorbed or stripped contaminant may be contacted with an oxidizing agent, as described herein, which in turn may convert the contaminant to less toxic and/or non-toxic byproducts, or in another embodiment, fully degrade the contaminant to CO₂, H₂O, O₂ and optionally trace quantities of ions.

In one embodiment, this invention provides a decontaminating method comprising the steps of:

a. contacting a fluid comprising a contaminant and carbon-based: nanoparticles, nanofibers, nano-fullerenes, nanotubes, hydrophobic nanoparticles or combination thereof wherein said contacting is for a period of time sufficient to adsorb said contaminant on at least a part of an exposed surface of said carbon-based: nanoparticles, nanofibers, nano-fullerenes, nanotubes, hydrophobic nanoparticles or combination thereof; and
b. isolating said carbon-based: nanoparticles, nanofibers, nano-fullerenes, nanotubes, hydrophobic nanoparticles or combination thereof comprising adsorbed contaminant from said fluid in (a);
thereby decontaminating said fluid.

In one embodiment, this invention provides a decontaminating method comprising the steps of:
a. contacting a fluid comprising a contaminant with carbon-based: nanoparticles, nanofibers, nano-fullerenes, nanotubes, hydrophobic nanoparticles or a combination thereof for a period of time sufficient to adsorb said contaminant on at least a part of an exposed surface of said carbon-based: nanoparticles, nanofibers, nano-fullerenes, nanotubes, hydrophobic nanoparticles or combination thereof; and
b. contacting said fluid in (a) with an oxidizing agent and metal nanoparticles,
   whereby said adsorbed contaminant is degraded.

In one embodiment, the contaminant is 100% adsorbed on the carbon-based: nanoparticles, nanofibers, nano-fullerenes, nanotubes, hydrophobic nanoparticles or combination thereof, or in another embodiment, 90-100% adsorbed, or 80-100% adsorbed on the carbon-based: nanoparticles, nanofibers, nano-fullerenes, nanotubes, hydrophobic nanoparticles or combination thereof. In another embodiment, the contaminant is 50-100% adsorbed on the carbon-based: nanoparticles, nanofibers, nano-fullerenes, nanotubes, hydrophobic nanoparticles or combination thereof. In another embodiment, the contaminant is 50-70% adsorbed on the carbon-based: nanoparticles, nanofibers, nano-fullerenes, nanotubes, hydrophobic nanoparticles or combination thereof.

In one embodiment, the concentration of the carbon-based: nanoparticles, nanofibers, nano-fullerenes, nanotubes, hydrophobic nanoparticles or combination thereof in said fluid is such, so as to be sufficient to adsorb up to 100% of a contaminant in said fluid. In another embodiment the concentration is 0.01-0.1% w/w. In another embodiment the concentration is 0.1-1% w/w. In another embodiment the concentration is 0.1-50% w/w. In another embodiment the concentration is 0.1-1% w/w. In another embodiment the concentration is 1-5% w/w. In another embodiment the concentration is 5-10%. In another embodiment the concentration is 10-20% w/w. In another embodiment the concentration is 20-30% w/w. In another embodiment the concentration is 30-40% w/w. In another embodiment the concentration is 40-50% w/w.

In one embodiment, the adsorption of the contaminant to the carbon-based: nanoparticles, nanofibers, nano-fullerenes, nanotubes, hydrophobic nanoparticles or combination thereof, occurs between about 1-10 seconds, or in another embodiment, between about 10-30 seconds, or in another embodiment, between about 30-60 seconds, or in another embodiment between about 1-5 minutes, or in another embodiment, between about 5-10 minutes, or in another embodiment between about 5-15 minutes, or in another embodiment, between about 15-60 minutes, or in another embodiment within 5 hours (h), or in another embodiment, between about 0-5 h, or in another embodiment, between about 5-10 h, or in another embodiment, between about 10-18 h, or in another embodiment, between about 10-24 h, or in another embodiment, between about 24-48 h, or in another embodiment, between about 24-72 h, or in another embodiment, between about 48-72 h.

In another embodiment, the adsorption of the contaminant is conducted at a temperature of between about 20-30° C., or in another embodiment, between about 30-35° C., or in another embodiment, between about 35-40° C., or in another embodiment, between about 40-45° C., or in another embodiment, between about 45-50° C., or in another embodiment, between about 50-60° C., or in another embodiment, between about 60-80° C., or in another embodiment, between about 20-60° C., or in another embodiment, between about 20-80° C., or in another embodiment between about 0-80° C., or in another embodiment between about 4-80° C., or in another embodiment above 80° C.

In another embodiment, the adsorbed contaminant is further oxidized, under aerobic conditions by an oxidizing agent, for a period of time sufficient to partially or fully degrade said contaminant. In one embodiment, the period of time sufficient to degrade the contaminant comprises any embodiment as herein described.

In one embodiment, the term “isolating” refers to the removal of the adsorbed material from the fluid, whereby removal constitutes the detoxification or decontamination of the fluid. In one embodiment, the term “isolating” signifies that the adsorbed material may be concentrated and used, or otherwise manipulated. In some embodiments, the term isolating” refers to the removal from the fluid; however the adsorbed material is not readily recoverable.

In one embodiment this invention provides a decontamination device, comprising:
a. an inlet for the introduction of a fluid into said device;
b. a reaction chamber comprising carbon-based: nanoparticles, nanofibers, nano-fullerenes, nanotubes, hydrophobic nanoparticles or combination thereof;
c. a first channel, which conveys said fluid from said inlet to said reaction chamber;
d. an outlet; and
e. a second channel, which conveys said fluid from said reaction chamber to said outlet;
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed thereto, and decontaminated fluid is conveyed from said reaction chamber to said outlet.

In one embodiment, this invention provides a method of decontamination of a fluid, the method comprising the step of applying fluid comprising a contaminant to a decontamination device comprising, said device comprising:
a. an inlet for the introduction of a fluid into said device;
b. a reaction chamber comprising carbon-based: nanoparticles, nanofibers, nano-fullerenes, nanotubes, hydrophobic nanoparticles or combination thereof;
c. a first channel, which conveys said fluid from said inlet to said reaction chamber;
d. an outlet; and
e. a second channel, which conveys said fluid from said reaction chamber to said outlet;
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed thereto, and decontaminated fluid is conveyed from said reaction chamber to said outlet.

In one embodiment, this invention provides a decontamination device, comprising:
a. an inlet for the introduction of a fluid;
b. an outlet;
c. a first reaction chamber comprising carbon-based: nanoparticles, nanofibers, nano-fullerenes, nanotubes, hydrophobic nanoparticles or combination thereof;
d. a second reaction chamber comprising metal nanoparticles;
e. a first channel, which conveys fluid from said inlet to said first reaction chamber;
f. a second channel, which conveys fluid from said first reaction chamber to said second reaction chamber; and
g. a third channel, which conveys said fluid from said second reaction chamber to said outlet;
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed at least a portion of said contaminant thereto, and fluid is conveyed from said first reaction chamber to said second reaction and contacted with said metal nanoparticles under aerobic conditions for a period of time sufficient to degrade said contaminant, and fluid is conveyed from said reaction chamber to said outlet.

In another embodiment, the first reaction chamber of the devices of this invention comprises a series of chambers, inter-connected by a series of channels, each chamber comprising carbon-based: nanoparticles, nanofibers, nano-fullerenes, nanotubes, hydrophobic nanoparticles or combination thereof. In another embodiment, the first reaction chamber of the device comprises between 1-10 chambers, inter-connected by a series of channels, each chamber comprising carbon-based: nanoparticles, nanofibers, nano-fullerenes, nanotubes, hydrophobic nanoparticles or combination thereof. In another embodiment, the first reaction chamber of the device comprises between 2-5 chambers.

In another embodiment, the second reaction chamber of the devices of this invention comprises a series of chambers, inter connected by a series of channels, each channel comprising metal nanoparticles. In another embodiment, the second reaction chamber of the device comprises between 1-10 chambers, inter-connected by a series of channels, each chamber comprising metal nanoparticles. In another embodiment, the second reaction chamber of the device comprises between 2-5 chambers.

In another embodiment, the devices of this invention comprise an alternating arrangement of said first reaction chamber and said second reaction chamber. In another embodiment, the alternating arrangement comprises a first reaction chamber, a second reaction chamber, a first reaction chamber and another second reaction chamber, inter connected by a series of channels.

In another embodiment, the device comprises a separate channel for conveying said fluid to said first reaction chamber or second reaction chamber. In another embodiment, the device further comprises, at least one inlet for the introduction of carbon-based: nanoparticles, nanofibers, nano-fullerenes, nanotubes, hydrophobic nanoparticles to said first reaction chamber or metal nanoparticles to said second reaction chamber. In another embodiment, the device further comprises, at least one inlet for the introduction of an oxidizing agent to said second reaction chamber.

In one embodiment, this invention provides a method of decontamination of a fluid, the method comprising the step of applying a fluid comprising a contaminant to a decontamination device, said device comprising
a. an inlet for the introduction of a fluid;
b. an outlet;
c. a first reaction chamber comprising carbon-based: nanoparticles, nanofibers, nano-fullerenes, nanotubes, hydrophobic nanoparticles or combination thereof;
d. a second reaction chamber comprising metal nanoparticles;
e. a first channel, which conveys fluid from said inlet to said first reaction chamber;
f. a second channel, which conveys fluid from said first reaction chamber to said second reaction chamber; and
g. a third channel, which conveys said fluid from said second reaction chamber to said outlet;
   whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed at least a portion of said contaminant thereto, and fluid is conveyed from said first reaction chamber to said second reaction and contacted with said metal nanoparticles under aerobic conditions for a period of time sufficient to degrade said contaminant, and fluid is conveyed from said reaction chamber to said outlet.

In one embodiment, the term “sufficient time” refers to a period of time for achieving the desired outcome. In one embodiment, the term “sufficient time” in reference to adsorption of the contaminant to a nanoparticles, nanofibers, nano-fullerenes, nanotubes, hydrophobic nanoparticles or combination thereof, and for use in this invention, is a period of time to achieve the minimum percent adsorption as described herein. In one embodiment, the term “sufficient time” refers to the period of time required for contact of the materials, in order to achieve a described percent adsorption of the contaminants.

In one embodiment, the reaction chamber may comprise any embodiment as described herein.

In one embodiment, carbon-based: nanoparticles, nanofibers, nano-fullerenes, nanotubes, hydrophobic nanoparticles or combination thereof are packed in the reaction chamber.

In one embodiment, carbon-based: nanoparticles, nanofibers, nano-fullerenes, nanotubes, hydrophobic nanoparticles or combination thereof are immobilized on or adsorbed to the substrate, and such immobilization and/or adsorption may comprise any embodiment as described herein, with regard to immobilization and/or adsorption of particles to a substrate or a solid support.

In another embodiment, the substrate or solid support is a metal surface, a semiconductor, a transparent surface, a non transparent surface, a Teflon, a silicon, a silicon oxide, a glass, a quartz, a transparent conducting oxide, a polymer, a membrane, minerals, natural materials, diatomite or an isolating surface. In another embodiment, the substrate or solid support is a bead, a tube, a column, a membrane or a fiber.

In one embodiment the carbon-based: nanoparticles, nanofibers, nano-fullerenes, nanotubes, hydrophobic nanoparticle or combination thereof are embedded in said substrate. In another embodiment, the substrate is zeolite.

In another embodiment, the contaminant is 100% adsorbed on the carbon-based: nanoparticles, nanofibers, nano-fullerenes, nanotubes hydrophobic nanoparticles or combination thereof or in another embodiment, the contaminant is 90-100% adsorbed, or in another embodiment, the contaminant is 80-100% adsorbed, or in another embodiment, 50-100% adsorbed, or in another embodiment, the contaminant is 50-70% adsorbed, or in another embodiment, 30-50% adsorbed on the carbon-based: nanoparticles, nanofibers, nano-fullerenes, nanotubes, hydrophobic nanoparticles or combination thereof.

In one embodiment, the carbon-based: nanoparticles, nanofibers, nano-fullerenes, nanotubes, hydrophobic nanoparticles or combination thereof are recovered, reused, recycled or regenerated following their decontamination, detoxification or concentration of material within the fluid. In one embodiment, recovery is accomplished thermally and by washing the nanoparticles, and/or filtration. In another embodiment, recovery, reusing, recycling or regenerating is accomplished by centrifugation. In another embodiment by heating and/or washing, centrifugation and/or filtration of the nanoparticles, is accomplished with use of a solvent, such as, for example, strong acid, water, polar solvents or combination thereof.

In one embodiment, diesel fuel is adsorbed on multi-walled nanotubes, or in another embodiment, diesel fuel is adsorbed on graphite, or, in another embodiment, gasoline is adsorbed on multi-walled nanotubes, or in another embodiment gasoline is adsorbed on graphite, or, in another embodiment, isomers of dichlorobenzene, are adsorbed on multi-walled carbon nanotubes, or, in another embodiment difluorobenzene is adsorbed on multi-walled carbon nanotubes, or, in another embodiment dibromobenzene is adsorbed on multi-walled carbon nanotubes, or, in another embodiment diiodobenzene is adsorbed on multi-walled carbon nanotubes, or, in another embodiment trichlorobenzene is adsorbed on multi-walled carbon nanotubes, or, in another embodiment naphthalene is adsorbed on multi-walled carbon nanotubes.

In one embodiment, estradiol is adsorbed on graphite, or in another embodiment, acetaminophen is adsorbed on graphite, or in another embodiment, penicillin G is adsorbed on graphite.

Examples 5 and 8 presented hereinbelow represent some embodiments of the methods of this invention for the decontamination, detoxification and/or concentration of a material in a fluid, by adsorption on graphite and multi-wall carbon nanotubes.

Some embodiments of the use of the fluids, kits and/or the devices of this invention are provided in the Figures herein and are for illustrative purposes alone, representing embodiments of this invention and in no way are to be considered to limit the scope of the invention.

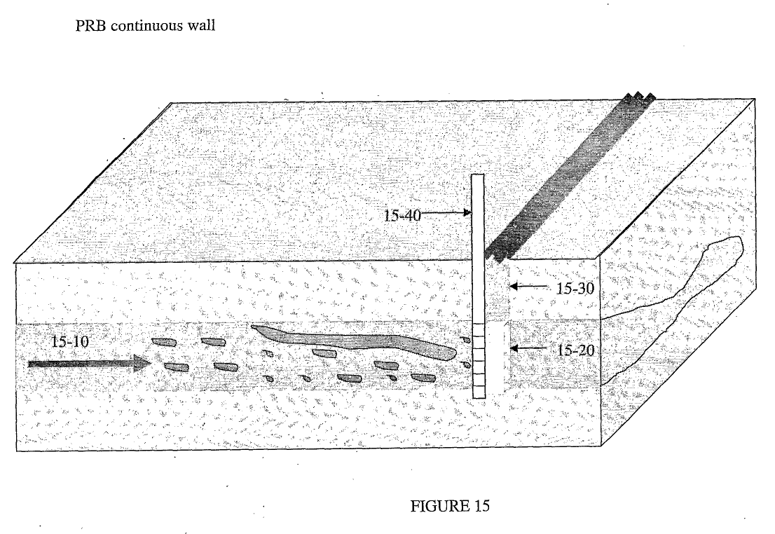

One embodiment of an envisioned application of the methods, fluids and/or kits of this invention is depicted in FIG. 15. In one embodiment, such an arrangement may be desirable for the decontamination of groundwater, by creating a subsurface permeable reactive barrier, wherein an in-ground trench (15-30) is backfilled with nanoparticles (15-20), where the nanoparticles are packed directly in the space created, or in some embodiments, are contained within a permeable layer or material, etc. According to this aspect of the invention, and in one embodiment, such an arrangement provides for passive treatment of contaminated ground water passing through the region defined by the trench. In some embodiments, such an arrangement may further comprise insertion of a screened well or like structure (15-40), comprising an oxidizing agent, which allows for flow-through in the confines of the structure containing the oxidizing agent, and does not significantly impeded flow through, or alter the characteristics of the flow through, save the initiation of the decontamination process. In another embodiment, the decontaminated water may be further returned to the groundwater.

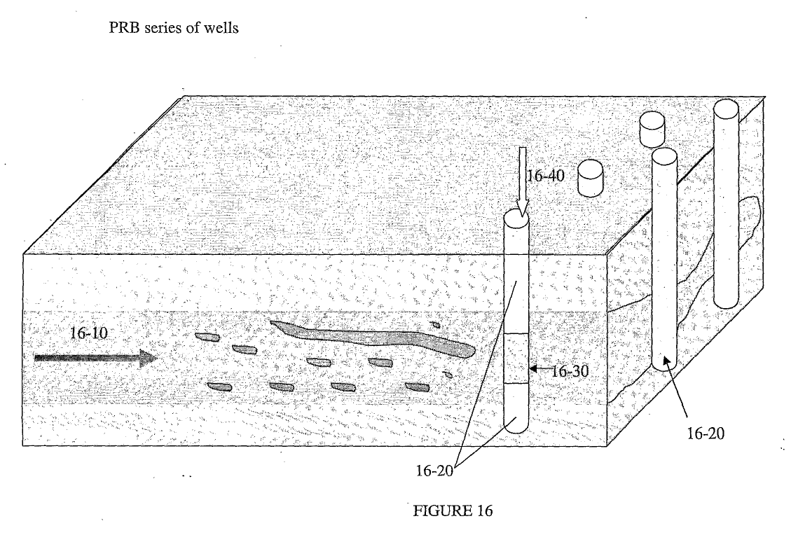

One embodiment of an envisioned application of the methods, fluids and/or kits of this invention is depicted in FIG. 16. In one embodiment, such an arrangement may be desirable for the decontamination of groundwater, by creating a subsurface permeable reactive barrier, wherein in-ground wells (16-20) are filled in whole or in part with nanoparticles (16-30) that direct groundwater towards a permeable treatment zone to provide passive treatment of contaminated ground-water. In some embodiments, such an arrangement may further comprise insertion by injection of an oxidizing agent, or the like (16-40), which allows for flow-through in the confines of the structure containing the oxidizing agent, and, in some embodiments, does not impede, or significantly impede flow-through, or alter the characteristics of the flow-through.

In another embodiment, such an arrangement may be desirable for the decontamination of reactors comprising solvents, or other fluids, wherein such permeable wells are introduced therein. In another embodiment, the decontaminated water may be returned to the groundwater.

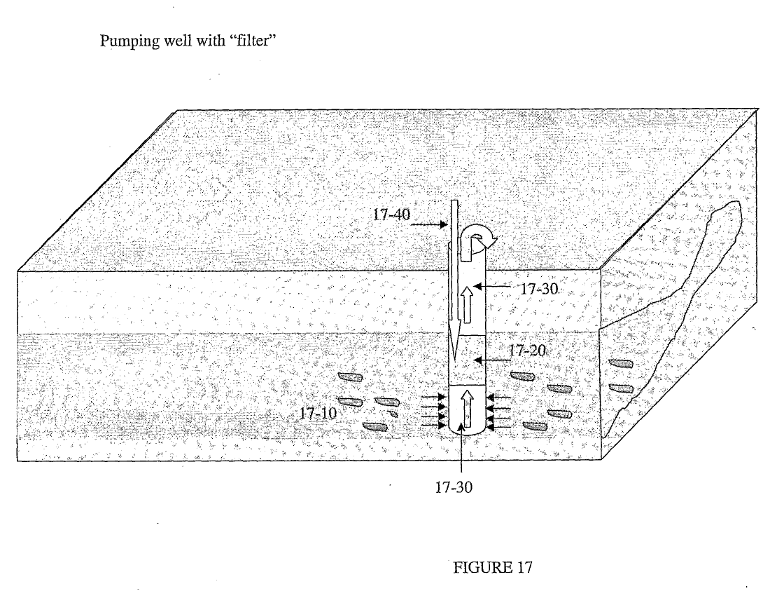

Another embodiment of an envisioned application of the methods, fluids and/or kits of this invention is depicted in FIG. 17. According to this aspect, and in one embodiment, such an arrangement may be desirable for the decontamination of groundwater, by pumping the contaminated ground water (17-10), using a series of extraction wells. Water is flowed through each well (17-30) and thereby passively flowed through the nanoparticles placed within (17-20), which are placed in some embodiments, within a filter, or mesh, or in other embodiments, are immobilized in a solid support, which is placed within the well. In some embodiments, such an arrangement may further comprise insertion of an oxidizing agent, by injection or like (17-40), which allows for flow-through in the confines of the structure containing the oxidizing agent, which in some embodiments, is so constructed so as to not impede, or not significantly impede flow through, or alter the characteristics of the flow through, save the initiation of the decontamination process.

In another embodiment, such an arrangement may be desirable for the decontamination of reactors comprising solvents, or other fluids, by pumping the fluids via the decontaminating well. In another embodiment, the decontaminated fluid may be further pumped into the extraction well. In another embodiment, the decontaminated water may be further returned to the groundwater.

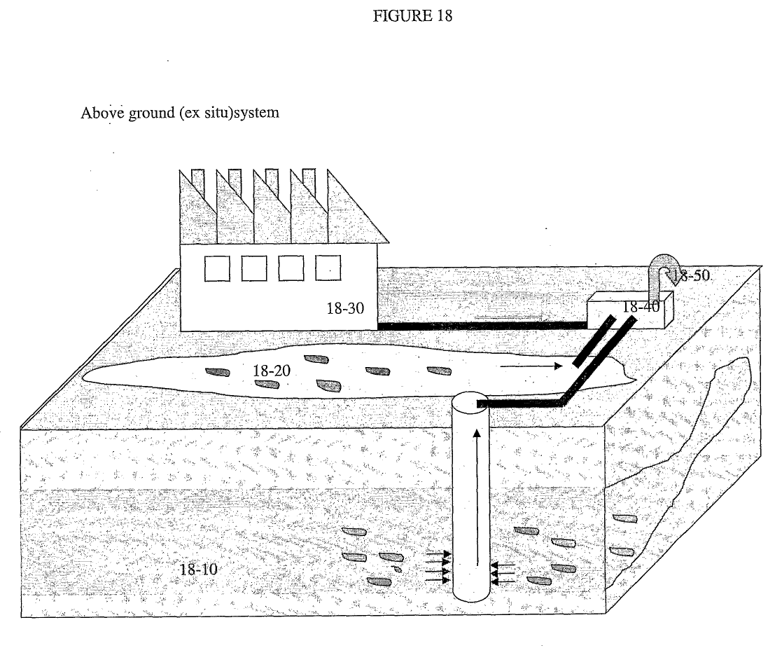

Another embodiment of an envisioned application of the methods, fluids and/or kits of this invention is depicted in FIG. 18. In one embodiment, such an arrangement may be desirable to decontaminate ground water (18-10), effluents (18-20) or surface water (18-30) by flowing the water through an aerobic reactor with nanoparticles (18-40) to remove the contaminants, to yield decontaminated water (18-50). In another embodiment, the decontaminated water may be further supplied to users or returned to the groundwater.

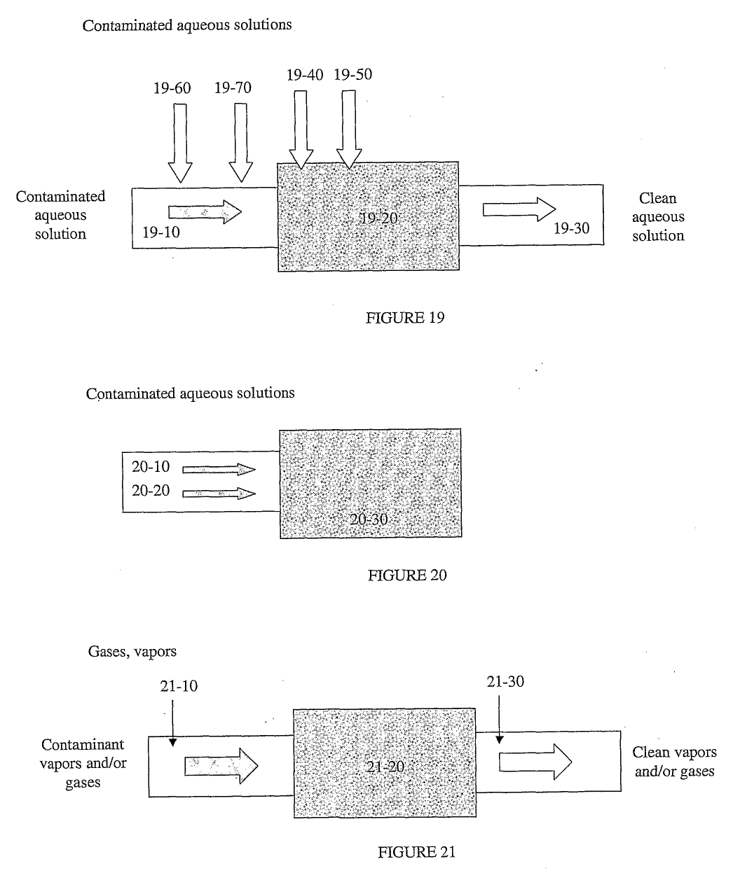

One embodiment of an envisioned application of the methods, fluids and/or kits of this invention is depicted in FIG. 19. In one embodiment, such an arrangement may be desirable to decontaminate aqueous solutions by flowing the contaminated solution (19-10) through an (aerobic) reactor containing nanoparticles (19-20), that can be further supplied to users or returned to the subsurface without the contaminant(s). In some embodiments, such an arrangement may further comprise additional ports (19-40) and (19-50) that allow introduction (or additional introduction of) of an oxidation agent and/or nanoparticles into the reaction vessel (19-20). In some embodiments, such an arrangement may further comprise additional ports (19-60) and (19-70) that allow introduction (or additional introduction of) of an oxidation agent and/or nanoparticles into the contaminated aqueous solution prior to entry into the reaction vessel (19-20). In some embodiments, such an arrangement may operate at variable flow rates. In some embodiments, such an arrangement may comprise a temperature controller. In some embodiments, such an arrangement may be scaled to nanograms, micrograms, grams, kg, or tons scale of contaminated fluids. In some embodiments, such an arrangement may comprise a feedback system where the decontaminated fluid may be further introduced into the reaction vessel (19-20). In some embodiments, such an arrangement may be automated or manually operated. In some embodiments, such an arrangement may be integrated in microfluidic devices.

One embodiment of an envisioned application of the methods, fluids and/or kits of this invention is depicted in FIG. 20. In one embodiment, such an arrangement may be desirable to decontaminate aqueous solutions in a reservoir (20-30) wherein nanoparticles (20-10) are added directly, or via port or conduit to the reservoir. In another embodiment an oxidizing agent (20-20) may be further added to the reservoir (20-30). In another embodiment, the nanoparticles are recycled following filtration. In some embodiments, such an arrangement may be scaled to nanograms, micrograms, grams, kg, or tons scale of contaminated fluids. In another embodiment the reservoir may comprise stirring devices. In another embodiment the reservoir may comprise a temperature controller or other environmental controls.

One embodiment of an envisioned application of the methods, fluids and/or kits of this invention is depicted in FIG. 21. In one embodiment, such an arrangement may be desirable to decontaminate aerobic vapors and/or gases containing pollutants by flowing the contaminated gas phase (21-10) through an aerobic reactor with nanoparticles (21-20), and/bubbled through an aqueous solution, to remove the contaminant(s) and receive clean vapors or gases (21-30) that can be further supplied to users or returned to the atmosphere without the contaminants. According to this aspect of the invention, and in some embodiments, the aqueous solution may comprise an oxidizing agent. In some embodiments, such an arrangement may further comprise additional ports that allow introduction (or additional introduction of) of an oxidizing agent and/or nanoparticles into the reactor. In some embodiments, such an arrangement may operate at variable flow rates. In some embodiments, such an arrangement may operate at variables pressures. In some embodiments, such an arrangement may comprise a pressure controller and a pressure release valve. In some embodiments, such an arrangement may comprise a temperature controller. In some embodiments, such an arrangement may be scaled to nanograms, micrograms, grams, kg, or tons scale of contaminated gases. In some embodiments, such an arrangement may comprise a feedback system where the decontaminated gases may be further introduced into the reactor. In some embodiments, such an arrangement may be automated or manually operated.

It is to be understood that numerous embodiments have been described herein regarding the materials and methods whereby the decontamination, detoxification and/or concentration of a material in a fluid may be accomplished, and that any embodiment as such represents part of this invention, as well as multiple combinations of any embodiment as described herein, including combinations of charged-metal and/or carbon-based and/or hydrophobic nanoparticles, oxidizing agents, fluids, in any conceivable combination and via their use in any method or embodiment thereof, as described herein, and as will be appreciated by one skilled in the art.

The following examples are presented in order to more fully illustrate the preferred embodiments of the invention. They should in no way be construed, however, as limiting the broad scope of the invention.

### EXAMPLES

### Example 1

### Decontamination of Monochlorobenzene and Dichlorobenzene

### Materials and Methods

### Reagents:

Monochlorobenzene, dichlorobenzene, Fe₃O₄ Iron (II,III) oxide nanopowder, >98%, 20-30 nm, BET (Brunauer, Emmett and Teller) surface area >60 m²/g, Sigma-Aldrich cat# 637106; TiO₂ Titanium(IV) oxide nanopowder, 99.9% 25-70 nm avg. particle size (xrd), BET surf. area 20-25 m²/g Sigma-Aldrich cat# 634662; TiC Titanium (IV) carbide nanopowder, >98% 130 nm avg. particle size BET surf. area 25-45 m²/gm Sigma-Aldrich cat #636967, were all purchased from Aldrich. H₂O₂/H₂0 was employed at a concentration of 30% v/v Merck, Germany.

### Process:

Iron oxide nanoparticles (0.1 g) were suspended in an aqueous solution (15 mL) containing 50 mg/L monochlorobenzene. Subsequently 2 mL of H₂O₂ 30% was added. The reaction mixture was stirred in a sealed 50 mL reactor for 48-72 h at room temperature. The nanoparticles were filtered off and ready for reuse. The aqueous reaction solutions were extracted by toluene or dichloromethane (by mixing the reaction vial content with 3 mL solvent) and the extract was then injected to the GC to determine the products and yield of degradation. This process was repeated for dichlorobenzene (50 mg/L) using iron oxide nanoparticles, and for titanium oxide or titanium carbide using monochlorobenzene or dichlorobenzene.

Varian Saturn 2000 GC/MS (gas chromatography/mass spectra) instrument was used equipped with VF-5ms (factor four capillary column), 25 meter length, 0.25 mm inner diameter, and 0.25 micron film layer thickness. The GC carrier gas was helium (He), at a flow rate of 1 ml per minute. The GC temperature program for each compound analyzed was as follows: MCB (monochlorobenzene) and DCB (dichlorobenzene): GC temperature program: 50° C. for 4 minutes; temperature ramp of 3.5° C. per minute to 120° C.; temperature ramp of 25° C. per minute to 180° C. Injector temperature was maintained at 270° C.

### Results

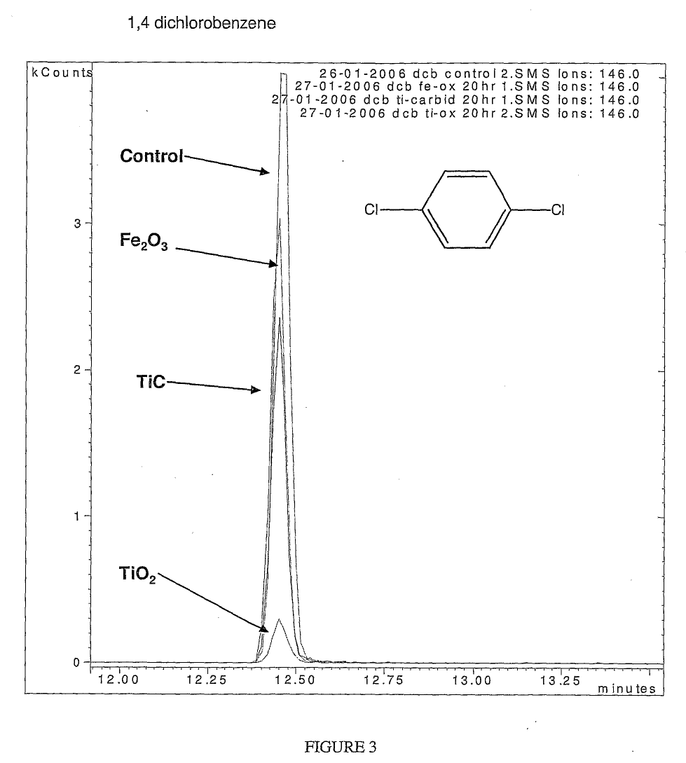

Degradation products of monochlorobenzene and dichlorobenzene contaminants using three metal-containing particles (Fe₃O₄, TiO₂, and TiC) nanoparticles were analyzed by GC-MS. GC-MS was used to confirm that no organic by-products were produced following the degradation of the contaminants, by the embodied method employed herein. The activity towards the degradation of monochlorobenzene and dichlorobenzene was in the order: Ti-oxide>Ti-carbide>Fe oxide in term of reaction rate/speed of reaction (FIG. 3). Thus, the method achieved 100% degradation, after 72 h, using titanium oxide yielding CO₂, H₂O and Cl⁻.

### Example 2

### Various Examples of Decontamination

### Materials and Methods

### Reagents:

Copper oxide, iron oxide, titanium oxide, titanium carbide, zinc oxide, silicon nitride, Lindane; polyaromatic hydrocarbons (PAHs) [e.g., naphthalene, phenanthrene, anthracene] were purchased from Sigma-Aldrich. Tribromoneopentyl alcohol (TBNPA); Tribromophenol (TBP) were received from Dead Sea Bromine Group (DSBG). Diesel fuel and gasoline were purchased in a gas station. H₂O₂/H₂O was employed at a concentration of 30% v/v Merck, Germany.

### Process:

Copper oxide nanoparticles (0.1 g) were suspended in an aqueous solution (15 mL) containing 50 mg/L tribromoneopentyl alcohol. Subsequently, 2 mL H₂O₂ 30% was added. The reaction mixture was stirred in a sealed 50 mL reactor for 48-72 hours at room temperature. The nanoparticles were filtered off and ready for reuse. The aqueous reaction solutions were extracted by toluene or dichloromethane (by mixing the reaction vial content with 3 mL solvent) and the extract was then injected to the GC/MS and GC/FID to determine the products and yield of degradation. This process was repeated for tribromophenol, Lindane, polyaromatic hydrocarbons (naphthalene, phenanthrene, anthracene), diesel fuel, gasoline using copper oxide nanoparticles, and the same contaminants were used each with the following metal nanoparticles: iron oxide, titanium carbide, titanium oxide or silicon nitride.

Varian Saturn 2000 GC/MS instrument equipped with VF-5ms (factor four capillary column), 25 meter length, 0.25 mm inner diameter, and 0.25 micron film layer thickness or HP 5890 GC instrument, equipped with an flame ionization detector (FID), and a J&W Scientific, DB5ms capillary column, 25 meter length, 0.25 mm inner diameter, and 0.25 micron film layer thickness were used for sample analysis. The GC carrier gas was helium (He), at a flow rate of 1 ml per minute.

The GC temperature program for each compound analyzed was as follows:

Lindane, tribromoneopentyl alcohol (TBNPA), and tribromophenol (TBP): GC temperature program: 50° C. for 5 minute; temperature ramp of 10° C. per minute to 250° C.; hold for 5 minutes. Injector temperature was maintained at 270° C.

Naphthalene, phenanthrene, anthracene (PAHs): GC temperature program: 80° C. for 13 minutes; temperature ramp of 15° C. per minute to 240° C.; temperature ramp of 30° C. per minute to 300° C. Injector temperature was maintained at 270° C.

Gasoline: GC temperature program: 40° C. for 3 minute; temperature ramp of 4° C. per minute to 100° C.; temperature ramp of 50° C. per minute to 200° C. Injector temperature was maintained at 270° C.

### Results

Table 1 sets forth the fluid compositions used, in terms of the contaminants and respective nanoparticles tested.

TABLE 1

| Contaminants | Nanoparticle Composition | | | | |
|---|---|---|---|---|---|
| (concentration) | Copper | Iron | Titanium | Titanium | Silicon |
| polyaromatic | + | + | + | + | + |
| hydrocarbons | | | | | |

Degradation products of tribromoneopentyl alcohol, tribromophenol, Lindane, polyaromatic hydrocarbons, diesel fuel, and gasoline contaminants mixed with nanoparticles comprised of copper oxide (CuO), iron oxide (Fe₂O₃), titanium oxide (TiO₂), titanium carbide (TiC) or silicon nitride (SiN) nanoparticles and H₂O₂ were analyzed by GC-MS.

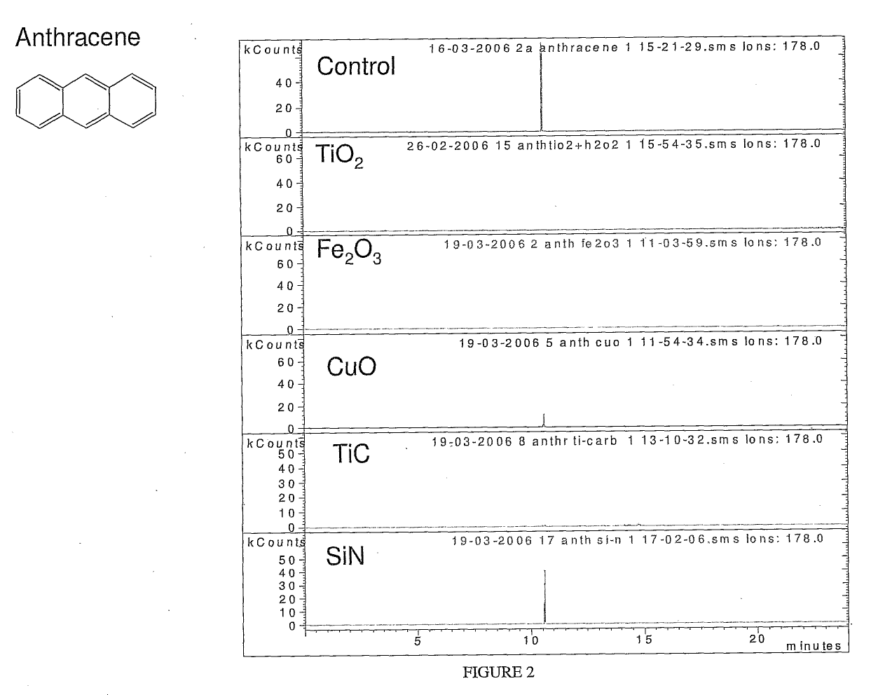

No organic by-products were produced following the degradation of anthracene using titanium oxide, iron oxide or titanium carbide and H₂O₂, as described herein in the method section indicating complete degradation (FIG. 2).

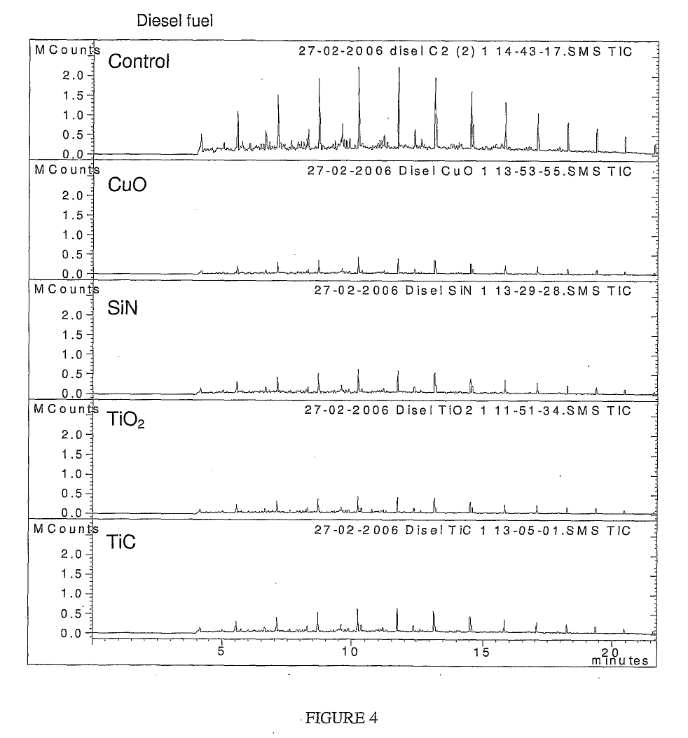

Degradation of diesel fuel using titanium oxide, copper oxide, silicon nitride or titanium carbide and H₂O₂, as described herein in the method section indicating about 80% degradation (FIG. 4).

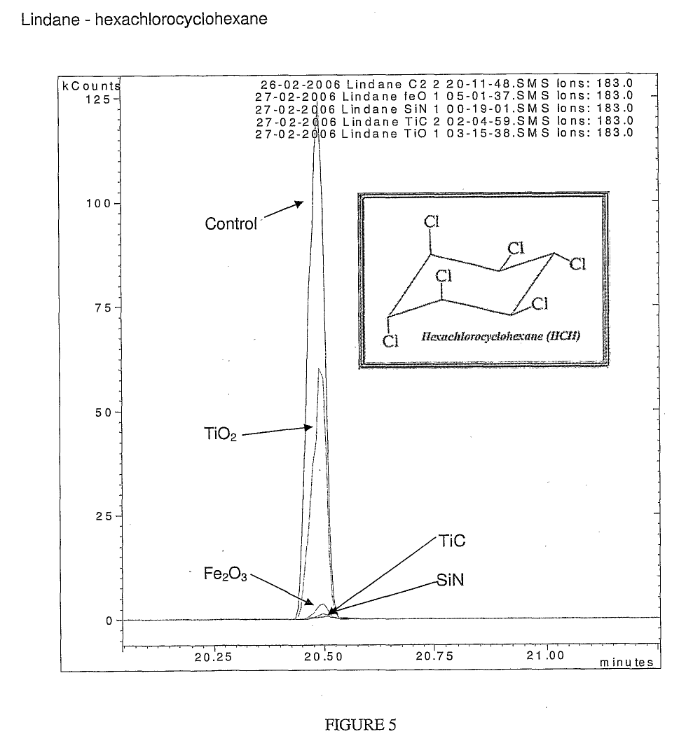

Degradation of Lindane using silicon nitride or titanium carbide and H₂O₂, as described herein in the method section indicating 98-100% degradation (FIG. 5).

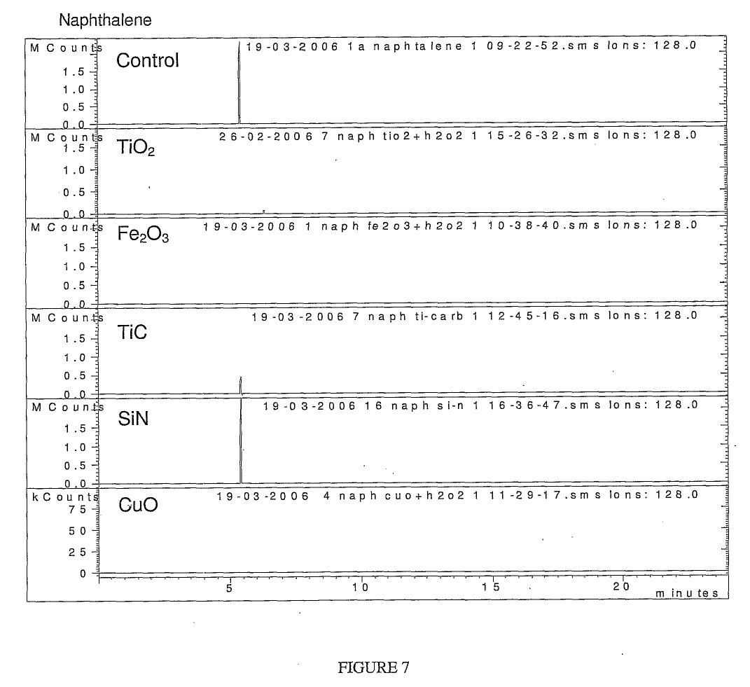

Degradation of naphthalene using iron oxide or copper oxide and H₂O₂, as described herein in the method section indicating complete degradation (FIG. 7).

Degradation of phenanthrene using titanium carbide, titanium oxide or copper oxide and H₂O₂, as described herein in the method section indicating complete degradation (FIG. 8).

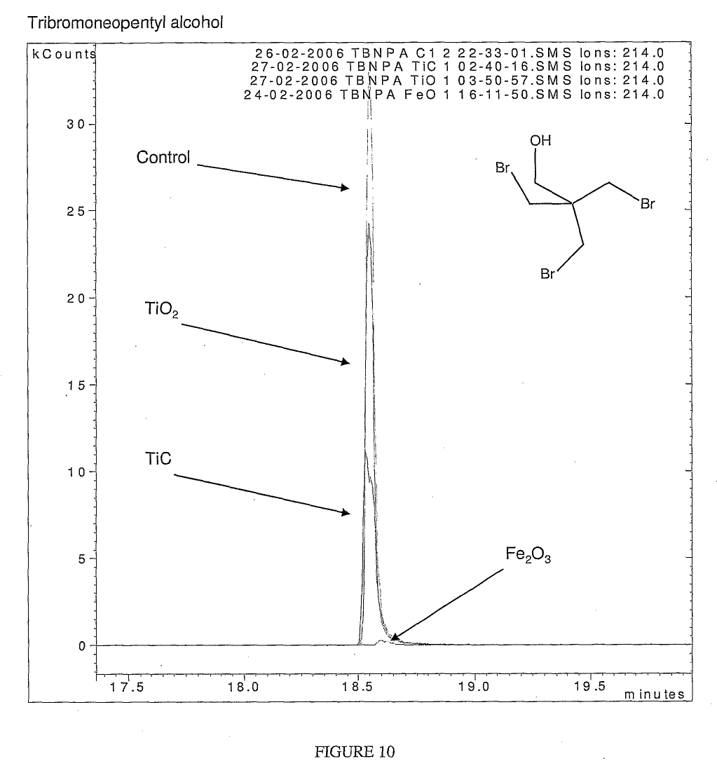

Degradation of tribromoneopentyl alcohol using titanium carbide, titanium oxide or iron oxide and H₂O₂, as described herein in the method section indicating about 76%, 49% and 100% degradation respectively (FIG. 10).

The symbol (+) of Table 1 indicates degradation of the contaminants to CO₂, O₂, H₂O, and trace quantities of ions, while empty cells indicate that the experiment was not conducted.

### Example 3

### Decontamination of Phenanthrene and Alachlor

### Reagents:

2-chloro-2′,6′-diethyl-N-methoxymethylacetanilide (Alachlor) was provided by Agan Chemical Manufacturers. Phenanthrene, CuO copper (II) oxide nanopowder, 33 nm, BET (Brunauer, Emmett and Teller) surface area 29 m²/g, cat# 544868, were purchased from Sigma-Aldrich. H₂O₂/H₂O was employed at a concentration of 30% v/v Merck, Germany.

### Process:

Copper oxide nanoparticles (0.2 g) were suspended in an aqueous solution (200 mL) containing 30 mg/L alachlor. Subsequently 2 mL of H₂O₂ 30% was added. The reaction mixture was sonicated in a 250 mL reactor for 30 minutes at room temperature.

Samples of the reaction solution were taken at different times and then extracted by n-hexane (by mixing 3 mL of the solution with 3 mL solvent). The extracts were injected to the GC to determine the concentration of alachlor. This process was repeated for phenanthrene (0.5 mg/L) using copper oxide nanoparticles (0.1 g).

In order to test if the reaction was photocatalytic, the same reaction was performed in complete darkness.

Different volumes of H₂O₂ (0.2, 1, 2, 3, 5 mL) were used to test the effect of concentration of H₂O₂ on reaction rate.

The effect of pH on reaction kinetics was tested by adjusting the pH of the solution by addition of NaOH or HCl.

A Varian Saturn 2000 GC/MS instrument was used equipped with VF-5ms (factor four capillary column), 25 meter length, 0.25 mm inner diameter, and 0.25 micron film layer thickness. The GC carrier gas was helium (He), at a flow rate of 1 mL per minute.

The GC temperature program was as follows:
Alachlor: 100° C. for 1 minute; temperature ramp of 20° C. per minute to 280° C. Injector temperature was maintained at 270° C.
Phenanthrene: 80° C. for 1 minute; temperature ramp of 15° C. per minute to 240° C.; 240° C. for 1.33 minutes; temperature ramp of 30° C. per minute to 300° C. Injector temperature was maintained at 270° C.

### Results:

### Phenanthrene:

99.24% degradation of phenanthrene was achieved after 30 minutes. The concentration of phenanthrene was plotted as a function of time (FIG. 8B). The reaction followed first order kinetics with respect to phenanthrene. The time constant was 5.45498±0.26042 minutes.

### Alachlor:

99.96% degradation of alachlor was achieved after 30 minutes, using 2 μL H₂O₂. Similar results were obtained with and without light, 99.96% degradation was achieved after 30 minutes. The concentration of alachlor was plotted as a function of time (FIG. 22). The reaction followed first order kinetics with respect to alachlor. The reaction time constants were 4.46±0.17 minutes (light) and 4.88±0.16 minutes (no light).

The concentration of alachlor was plotted as a function of time for different H₂O₂ concentrations (FIG. 23) and summarized in Table 2.

TABLE 2

| | Degradation after 30 | |
|---|---|---|
| Volume of H₂O₂ [mL] | minutes (%) | Time constant [minutes] |
| 0.2 | 95.80 | 8.43 ± 0.46 |
| 1 | 99.94 | 3.343 ± 0.04 |
| 2 | 99.96 | 4.46 ± 0.17 |
| 3 | 89.99 | |
| 5 | 86.03 | |

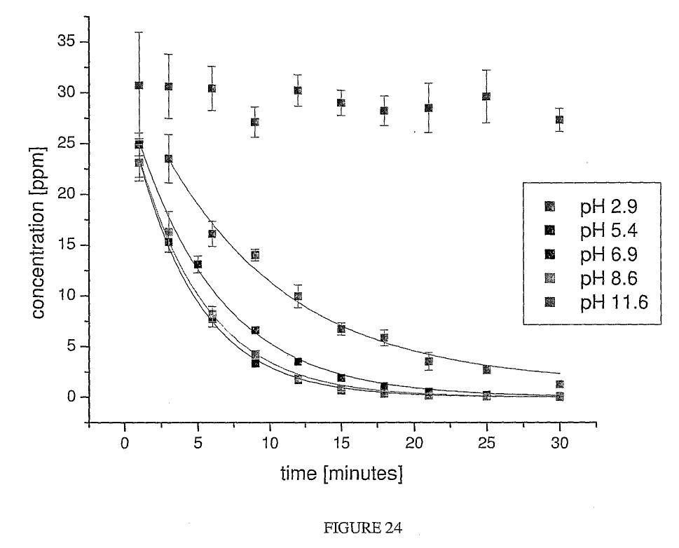

The concentration of alachlor was plotted as a function of time for different pH values (FIG. 24). The results are shown in Table 3. For pH 11.6 no decomposition was observed. For lower pH values, first order kinetics with respect to alachlor was observed.

TABLE 3

| | Degradation after 30 | |
|---|---|---|
| pH | minutes (%) | Time constant [minutes] |
| 2.9 | 95.80 | 8.94 ± 0.549 |
| 5.4 | 99.94 | 4.38 ± 0.11 |
| 6.9 | 99.70 | 5.82 ± 0.23 |
| 8.6 | 99.92 | 4.71 ± 0.16 |

### Example 4

### Decontamination of Pharmaceuticals

### Materials and Methods

### Reagents:

Estradiol, acetaminophen, penicillin G and iron oxide were all purchased from Sigma-Aldrich. H₂O₂/H₂0 was employed at a concentration of 30% v/v Merck, Germany

### Process:

Iron oxide nanoparticles (0.1 g) were mixed in an aqueous solution (15 mL) containing 50 mg/L acetaminophen. Subsequently, 2 mL of H₂O₂ 30% was added. The mixture was stirred in a sealed 50 mL reactor for 48-72 hours at room temperature. The mixture was analyzed by HPLC to determine the products and yield of degradation. The nanoparticles were filtered and ready for reuse. This process was repeated for penicillin (at a concentration of 50 mg/L) and estradiol (saturated solution), using iron oxide nanoparticles.

HPLC (Waters) equipped with C18 column and UV-VIS detector was used. Analysis program was done on the HPLC and the parameters for each compound were:
Acetaminophen: Retention time: 3.92 min; Flow rate: 1 cc/min; Mobile phase—75% acetonitrile, 25% water; Wavelength—270 nm.
Estradiol: Retention time: 3.21 min; Flow rate: 1 cc/min; Mobile phase—50% acetonitrile, 50% water; Wavelength—254 nm.
Penicillin G: Retention time: 1.90 min; Flow rate: 1 cc/min; Mobile phase—50% acetonitrile, 50% water; Wavelength—254 nm.

### Results

Degradation of estradiol, acetaminophen, penicillin G by mixtures of iron oxide nanoparticles and H₂O₂ was confirmed by HPLC.

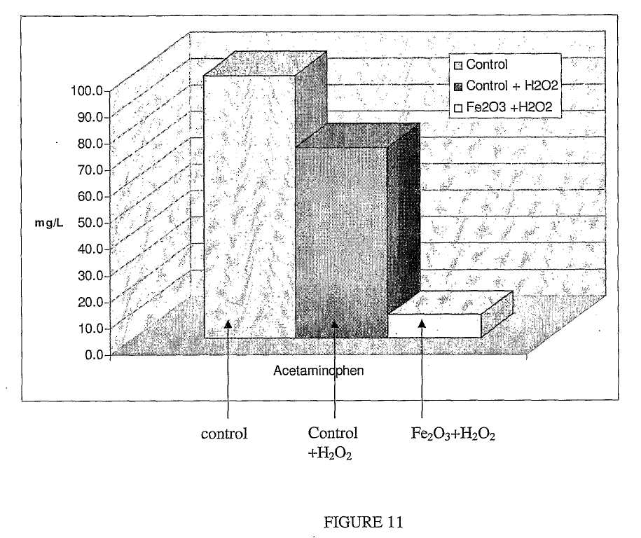

Degradation of acetaminophen using iron oxide and H₂O₂, as described herein in the method section indicating 98-100% degradation (FIG. 11).

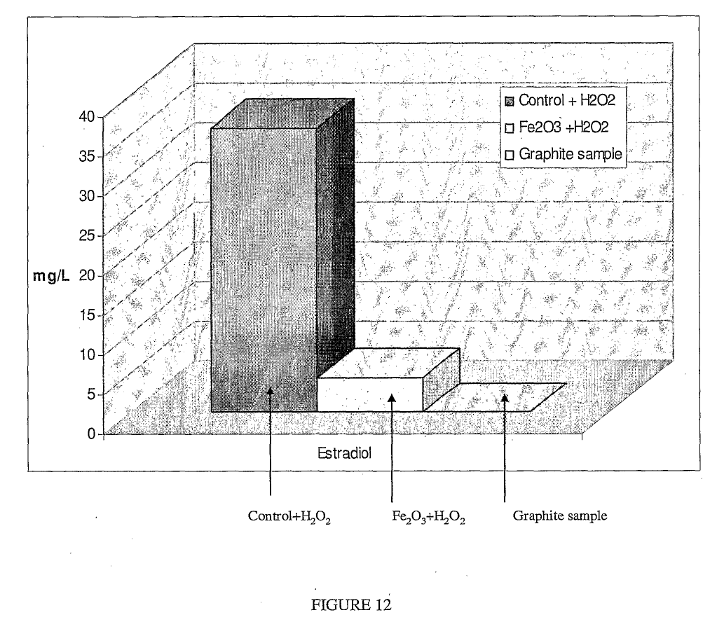

Degradation of estradiol using iron oxide and H₂O₂, as described herein in the method section indicating 85-90% degradation (FIG. 12).

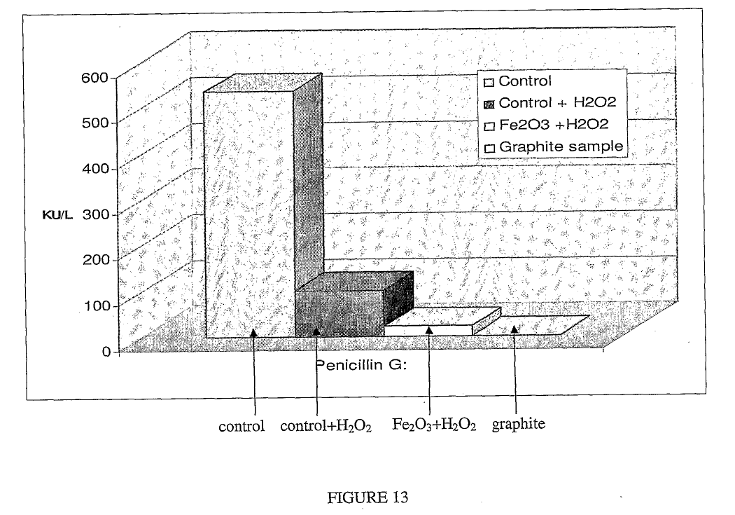

Degradation of penicillin G using iron oxide and H₂O₂, as described herein in the method section indicating complete 95% degradation (FIG. 13).

### Example 5

### Adsorption of Contaminants

### Materials and Methods

### Reagents:

Diesel fuel, gasoline were purchased at a gas station, estradiol, acetaminophen, penicillin G, naphthalene and phenanthrene multi-wall nanotubes Cat #659258 and graphite fibers Cat # 636398 were all purchased from Sigma-Aldrich.

### Process:

Graphite fibers (0.1 g) were added to an aqueous solution (15 mL) containing 50 mg/L of acetaminophen. The mixture was stirred at room temperature for 72 h in a sealed reactor. The fibers were filtered off and the solution was analyzed by HPLC.

Estradiol and penicillin G were similarly adsorbed to graphite fibers. Diesel fuel and gasoline were also similarly adsorbed to multi-walled nanotubes and graphite fibers, and the solutions were analyzed by GC/MS and GC-FID.

Analysis was done using GC/MS and GC-FID (diesel, gasoline) and HPLC (estradiol, penicillin G). The aqueous reaction solutions were extracted by toluene or dichloromethane (by mixing the reaction vial content with 3 ml solvent) and the extract is then injected to the GC.

Varian Saturn 2000 GC/MS instrument equipped with VF-5ms (factor four capillary column), 25 meter length, 0.25 mm inner diameter, and 0.25 micron film layer thickness or HP 5890 GC instrument, equipped with an flame ionization detector (FID), and a J&W Scientific, DB5ms capillary column, 25 meter length, 0.25 mm inner diameter, and 0.25 micron film layer thickness were used for sample analysis. The GC carrier gas was helium (He), at a flow rate of 1 ml per minute. The GC temperature program for each compound analyzed was as follows:

Diesel fuel: GC temperature program: 100° C. for 2 minutes; temperature ramp of 8° C. per minute to 250° C.; hold for 1 minute. Injector temperature was maintained at 270° C.

Gasoline: GC temperature program: 40° C. for 3 minutes; temperature ramp of 4° C. per minute to 100° C.; temperature ramp of 50° C. per minute to 200° C. Injector temperature was maintained at 270° C.

HPLC (Waters) equipped with a C18 column and uv-vis detector was used and the parameter analyses were as follows:

Estradiol: Retention time: 3.21 min; Flow rate: 1 cc/min; Mobile phase—50% acetonitrile, 50% water; Wavelength—254 nm.
Penicillin G: Retention time: 1.90 min; Flow rate: 1 cc/min; Mobile phase—50% acetonitrile, 50% water; Wavelength—254 nm.

### Results

Table 4 sets forth the area counts that are linearly proportional to concentration of estradiol and penicillin G solutions before and after adsorption on graphite fibers.

TABLE 4

| | Estradiol | Penicillin G |
|---|---|---|
| Control initial | 30597 | 5036582 |
| solution | | |
| Graphite sample | 0 | 0 |

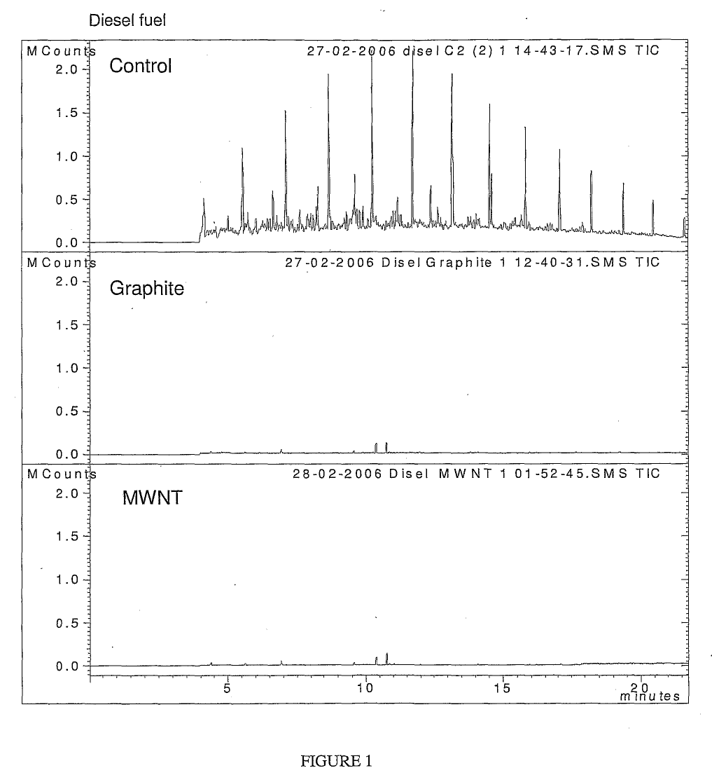

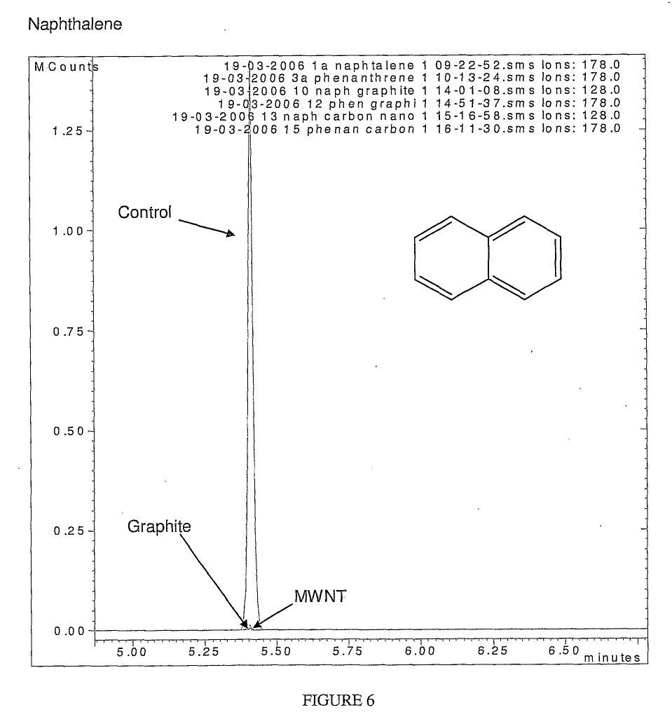

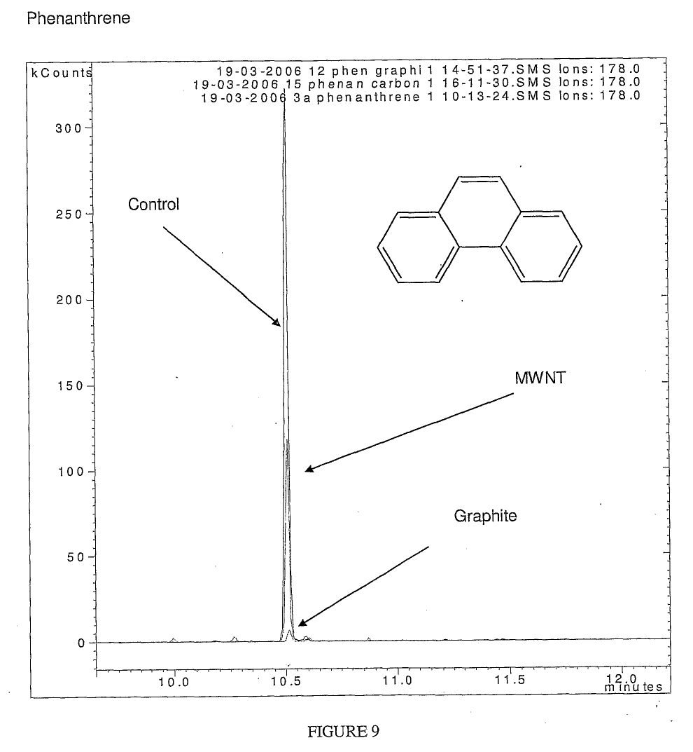

Adsorption of estradiol, penicillin G to graphite fibers resulted in complete decontamination (FIGS. 12 and 13). Adsorption of diesel fuel, gasoline or naphthalene to multi-walled nanotubes or graphite fibers also resulted in complete decontamination (FIGS. 1, 6 and 9).

### Example 6

### Degradation of Contaminants Under Aerobic Conditions without Addition of an Oxidizing Agent

### Materials and Methods

### Reagents:

Copper oxide, titanium oxide, titanium carbide, zinc oxide, silicon nitride, phenanthrene, monochlorobenzene, dichlorobenzene, were purchased from Sigma-Aldrich.

### Process:

Titanium oxide nanoparticles (0.1 g) were suspended in an aqueous solution (15 mL) containing 25 mg/L monochlorobenzene. The reaction mixture was stirred in a sealed 20 mL reactor for a week at room temperature at ambient light. The nanoparticles were filtered off and ready for reuse. The mixture was analyzed by GC-FID and to determine the products and yield of degradation. The aqueous reaction solutions were extracted by dichloromethane (by mixing the reaction vial content with 2.5 mL solvent) and the extract was then injected to the GC. This process was repeated for dichlorobenzene, and phenanthrene (saturated aqueous solution), and the same contaminants were used each with the following metal nanoparticles: copper oxide, titanium carbide or silicon nitride and zinc oxide.

HP 5890 GC instrument, equipped with a flame ionization detector (FID), and a J&W Scientific, DB5ms capillary column, 25 meter length, 0.25 mm inner diameter, and 0.25 micron film layer thickness were used for sample analysis. The GC carrier gas was helium (He), at a flow rate of 1 ml per minute.

The GC temperature program for each compound analyzed was as follows: Monochlorobenzene and dichlorobenzene: GC temperature program: 80° C. for 2 minutes; temperature ramp of 5° C. per minute to 120° C.; temperature ramp of 25° C. per minute to 180° C. Injector temperature was maintained at 270° C.

Phenanthrene: GC temperature program: 150° C. for 3 minutes; temperature ramp of 10° C. per minute to 250° C.; hold for 1 minute; temperature ramp of 15° C. per minute to 300° C.; hold for 2.67 minutes. Injector temperature was maintained at 270° C.

### Results

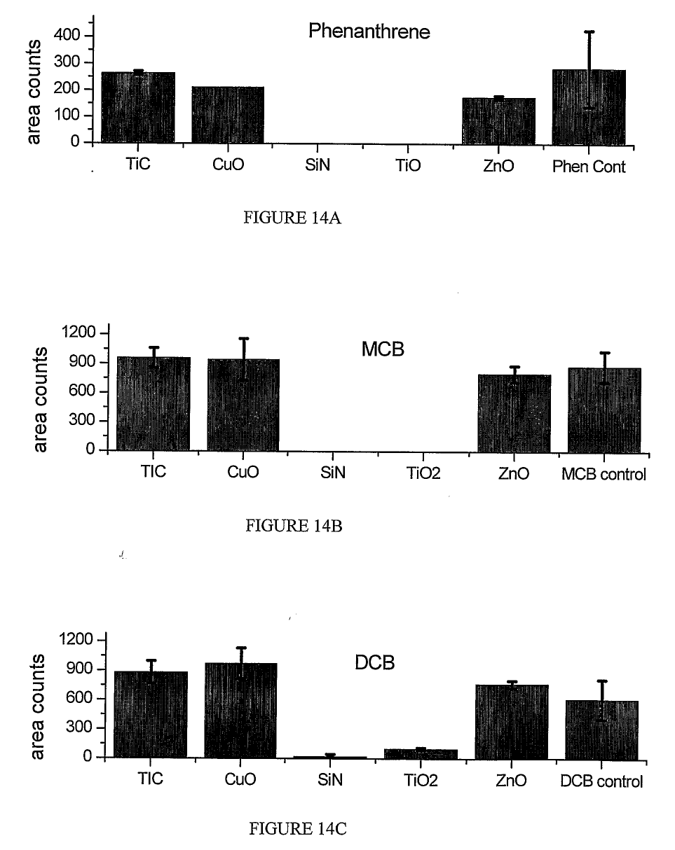

Degradation of phenanthrene, monochlorobenzene and dichlorobenzene by silicon nitride and titanium oxide nanoparticles was confirmed by GC-FID indicating complete degradation, and no formation of organic by-products under the conditions tested (FIG. 14).

### Example 7

### Temperature Effects on Decontamination Using Metal Nanoparticles and Hydrogen Peroxide

### Materials and Methods

### Reagents

Copper oxide, titanium carbide and naphthalene, were purchased from Sigma-Aldrich. H₂O₂/H₂O was employed at a concentration of 30% v/v Merck, Germany.

### Process:

Copper oxide nanoparticles (50 mg) were suspended in aqueous solution (7.5 mL) containing 20 mg/L naphthalene. Subsequently, 1 mL H₂O₂ 30% was added. The experiment was conducted at four different temperatures 4° C., 24° C. (room temp), 40° C., and 60° C. Samples were taken after 12, 36, and 72 hours to assess the effect over time of each temperature. The aqueous reaction solutions were extracted by toluene or dichloromethane (by mixing the reaction vial content with 3 mL solvent) and the extract was then injected to the GC/MS and GC/FID to determine the products and yield of degradation. This process was repeated using titanium carbide (50 mg).

### Results

Degradation of naphthalene by copper oxide and titanium carbide nanoparticles was confirmed by GC. For both types of nanoparticles, only very minor differences in degradation were seen. Most of the degradation reaction occurred within the first 12 hours (more than 95%-99.8% for CuO, 85%-99.8% for TiC). The final naphthalene concentration for all cases (after 72 hours) was less 0.5% of the initial concentration. The effect of temperature did not appear to be affected in this embodiment, when the specific particles and H₂O₂ were used, where activity was high for all temperatures tested, even at 4° C.

### Example 8

### Naphthalene Adsorption

### Materials and Methods

### Decontamination of Naphthalene in Solution Comprising MWCNT

### Reagents:

Naphthalene, Multiwall Carbon Nanotubes (MWCNT) were purchased from Sigma-Aldrich

### Process:

5 mg of MWCNTs was added to 40 ml of a 10 ppm Naphthalene in aqueous solution. The solution was mixed using an ultrasonic sonicator for 24 hours. 2 ml of cyclohexane was used to extract the remaining Naphthalene from 30 ml of the solution after 24 hours. This extract was injected into the GC-MS to determine the final concentration.

### Results

The concentration of the solution after 24 hours was calculated as 2.2±0.6 ppm. Assuming equilibrium, the adsorption capacity of the nanotubes for Naphthalene is 62.4 mg/g.

### Decontamination of Naphthalene by Flow Through Packed Nanotube Columns

### Reagents:

Naphthalene, Multiwall Carbon Nanotubes (MWCNT) [Aldrich]

### Process:

MWCNTs were packed into large pasteur pipettes using glass wool as a filter for the column. Three pipettes were packed in the following fashion:
1. 10 cm of glass wool was packed in the column (control)
2. 5 mg MWCNT were packed dry with 2-5 cm of glass wool above and below the MWCNTs
3. 10 mg MWNT were packed as in (1).
4. 10 mg MWNT were dispersed in THF, and then poured into a column containing 2-5 cm of glass wool, enabling the THF to drain off. The MWCNTs were rinsed, and glass wool was packed on top to seal in the MWCNTs.

10 cc of 10 ppm Naphthalene in aqueous solution through columns (1)-(4) at a rate of 0.3 ml/h into 40 ml glass vials sealed with Teflon caps. The system was closed. The remaining Naphthalene was extracted from the effluent using 2 ml of cyclohexane, and injected into the GC-MS for analysis of the concentration.

### Results

Table 5 outlines the percentage of Naphthalene adsorbed after being pumped through the various columns:

TABLE 5

| Column | Concentration Relative to control (%) |
|---|---|
| (2) 5 mg, packed dry | 34.6 |
| (4) 10 mg, packed with THF | 38.9 |
| (3) 10 mg, packed dry | 35.2 |

It will be appreciated by a person skilled in the art that the present invention is not limited by what has been particularly shown and described hereinabove. Rather, the scope of the invention is defined by the claims that follow.

1. A decontaminating fluid comprising a metal nanoparticle and an oxidizing agent, wherein if said nanoparticle is iron oxide, then said oxidizing agent is not O₂ or H₂O₂.

2. (canceled)

3. The decontaminating fluid of claim 1, wherein said nanoparticle is iron oxide, titanium oxide, titanium carbide, copper oxide, zinc oxide, silicon nitride, cerium oxide, zinc sulfide, titanium nitride or any combination thereof.

4. The decontaminating fluid of claim 1, wherein said oxidizing agent is a peroxide, hydrogen peroxide, a chromate, oxygen, ozone, a chlorate, a persulfate, a perchlorate, an electron acceptor, or any combination thereof.

5. (canceled)

6. The decontaminating fluid of claim 1, wherein said fluid is an aqueous solution.

7. The decontaminating fluid of claim 6, wherein said aqueous solution comprising NaCl at a concentration of between about 1-5M.

8. (canceled)

9. A decontaminating method comprising contacting a fluid comprising a contaminant with a metal nanoparticle comprising a charged metal wherein said contacting is conducted under aerobic conditions or with an oxidizing agent and is for a period of time sufficient to oxidize said contaminant to form a non-toxic compound, thereby decontaminating said fluid.

10. The method of claim 9, wherein said contaminant is a chemical contaminant, a biological contaminant, a wastewater, a hydrocarbon, an industrial effluent, a municipal or domestic effluent, sulfur containing effluents, a metal, an agrochemical, an herbicide, a pharmaceutical or any combination thereof.

11. The method of claim 9, wherein said nanoparticle is iron oxide, titanium oxide, titanium carbide, copper oxide, zinc oxide, silicon nitride, cerium oxide, zinc sulfide, titanium nitride or any combination thereof.

12. (canceled)

13. The method of claim 9, wherein said solution is an aqueous solution comprising NaCl at a concentration of between about 1-5M.

14-16. (canceled)

17. The method of claim 9, wherein said metal nanoparticles are immobilized on a solid support or embedded in a porous material.

18-27. (canceled)

28. The method of claim 9, wherein said oxidizing agent is oxygen, ozone, a peroxide, hydrogen peroxide, a chromate, a chlorate, a persulfate, a perchlorate, an electron acceptor, or any combination thereof.

29-38. (canceled)

39. A decontamination device, comprising:
a. an inlet for the introduction of a fluid into said device;
b. a reaction chamber comprising metal nanoparticles;
c. a first channel, which conveys said fluid from said inlet to said reaction chamber;
d. an outlet;
e. a second channel, which conveys said fluid from said reaction chamber to said outlet
whereby fluid comprising a contaminant is conveyed to said reaction chamber, and contacted with said metal nanoparticles under aerobic conditions for a period of time sufficient to degrade said contaminant, and decontaminated fluid is conveyed from said reaction chamber to said outlet.

40. The device of claim 39, further comprising a separate channel for conveying said fluid to the reaction chamber.

41. The device of claim 39, further comprising, at least one inlet for the introduction of an oxidizing agent, a nanoparticle, or combination thereof.

42. The device of claim 39, further comprising an environmental control, wherein said environmental control includes temperature, pressure and pH.

43. (canceled)

44. (canceled)

45. The device of claim 39, wherein said contaminant is a chemical contaminant, a biological contaminant, a wastewater, a hydrocarbon, an agrochemical, an herbicide, a pharmaceutical, an industrial effluent, a municipal or domestic effluent, sulfur containing effluents, a metal or any combination thereof.

46. (canceled)

47. The device of claim 46, wherein said nanoparticle is iron oxide, titanium oxide, titanium carbide, copper oxide, zinc oxide, silicon nitride, cerium oxide, zinc sulfide, titanium nitride or any combination thereof.

48. The device of claim 39, wherein said fluid is an aqueous solution comprising NaCl at a concentration of between about 1-5M.

49. (canceled)

50. The device of claim 41, wherein said oxidizing agent is oxygen, ozone, a peroxide, hydrogen peroxide, a chromate, a chlorate, a persulfate, a perchlorate, an electron acceptor, or any combination thereof.

51-53. (canceled)

54. The device of claim 39, wherein said nanoparticles are well-packed in said reaction chamber.

55. The device of claim 39, wherein said reaction chamber is a column.

56. The device of claim 39, wherein said nanoparticles are immobilized on a solid support or embedded in a porous material.

57-60. (canceled)

61. A method of decontamination of a fluid, said method comprising applying a fluid comprising a contaminant to a device of claim 39 at ambient aerobic conditions.

62. The method of claim 61, wherein said contaminant is a chemical contaminant, a biological contaminant, a wastewater, a hydrocarbon, an agrochemical, an herbicide, a pharmaceutical, an industrial effluent, a municipal or domestic effluent, sulfur containing effluents, a metal or any combination thereof.

63. The method of claim 61, wherein said fluid is an aqueous solution comprising NaCl at a concentration of between about 1-5M.

64. (canceled)

65. The method of claim 61, wherein the nanoparticles of said device are recovered and reused.

66. The method of claim 61, wherein an oxidizing agent and said metal nanoparticles are contacted in said device, before the introduction of said fluid comprising said contaminant.

67-82. (canceled)

83. A decontamination device, comprising:
a. an inlet for the introduction of a fluid into said device;
b. a reaction chamber comprising carbon-based: nanoparticles, nanofibers, nano-fullerenes, nanotubes, hydrophobic nanoparticles or combination thereof;
c. a first channel, which conveys said fluid from said inlet to said reaction chamber;
d. an outlet; and
e. a second channel, which conveys said fluid from said reaction chamber to said outlet;
whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed thereto, and decontaminated fluid is conveyed from said reaction chamber to said outlet.

84. The device of claim 83, further comprising a separate channel for conveying said fluid to the reaction chamber.

85. The device of claim 83 further comprising, at least one inlet for the introduction of a nanoparticle.

86. The device of claim 83, further comprising an environmental control, wherein said environmental control includes temperature, pressure and pH.

87. (canceled)

88. (canceled)

89. The device of claim 83, wherein said carbon-based: nanoparticles, nanofibers, nano-fullerenes, nanotubes, hydrophobic nanoparticles or combination thereof are well-packed, in said reaction chamber.

90. The device of claim 83 wherein said reaction chamber is a column.

91. The device of claim 83, wherein said carbon-based: nanoparticles, nanofibers, nano-fullerenes, nanotubes or hydrophobic nanoparticles or combination thereof are immobilized on a solid support or embedded in a solid support.

92-95. (canceled)

96. The device of claim 83, wherein said nanotubes are single-walled or multi-walled carbon-based nanotubes.

97. The device of claim 83, wherein said carbon-based nanofibers comprise graphite.

98. The device of claim 83, wherein said carbon-based: nanoparticles, nanofibers, nano-fullerenes, nanotubes, hydrophobic nanoparticles or combination thereof at a concentration sufficient to adsorb up to 100% of a contaminant in said fluid.

99. (canceled)

100. A decontaminating method comprising the steps of:
a. contacting a fluid comprising a contaminant with carbon-based: nanoparticles, nanofibers, nano-fullerenes, nanotubes, hydrophobic nanoparticles or a combination thereof for a period of time sufficient to adsorb said contaminant on at least a part of an exposed surface of said carbon-based: nanoparticles, nanofibers, nano-fullerenes, nanotubes, hydrophobic nanoparticles or combination thereof; and
b. contacting said fluid in (a) with an oxidizing agent and metal nanoparticles,
whereby said adsorbed contaminant is degraded.

101. The method of claim 100, wherein said oxidizing agent is oxygen, ozone, a peroxide, hydrogen peroxide, a chromate, a chlorate, a persulfate, a perchlorate, an electron acceptor, or any combination thereof.

102. (canceled)

103. (canceled)

104. The method of claim 100, wherein said contaminant is a chemical contaminant, a biological contaminant, a wastewater, a hydrocarbon, an agrochemical, an herbicide, a pharmaceutical, an industrial effluent, a municipal or domestic effluent, sulfur containing effluents, a metal or any combination thereof.

105. The method of claim 100, wherein said metal nanoparticle is iron oxide, titanium oxide, titanium carbide, copper oxide, zinc oxide, silicon nitride, cerium oxide, zinc sulfide, titanium nitride or any combination thereof.

106. A decontamination device, comprising:
a. an inlet for the introduction of a fluid;
b. an outlet;
c. a first reaction chamber comprising carbon-based: nanoparticles, nanofibers, nano-fullerenes, nanotubes, hydrophobic nanoparticles or combination thereof;
d. a second reaction chamber comprising metal nanoparticles;
e. a first channel, which conveys fluid from said inlet to said first reaction chamber;
f. a second channel, which conveys fluid from said first reaction chamber to said second reaction chamber;
g. a third channel, which conveys said fluid from said second reaction chamber to said outlet;
whereby fluid comprising a contaminant is conveyed to said reaction chamber and contacted with said carbon-based: nanoparticles, nanofibers, nano-fullerenes, nanotubes, hydrophobic nanoparticles or combination thereof; for a period of time sufficient to adsorbed at least a portion of said contaminant thereto, and fluid is conveyed from said first reaction chamber to said second reaction and contacted with said metal nanoparticles under aerobic conditions for a period of time sufficient to degrade said contaminant, and fluid is conveyed from said reaction chamber to said outlet.

107. The device of claim 106, wherein said first reaction chamber comprises a series of chambers, inter-connected by a series of channels, each chamber comprising carbon-based: nanoparticles, nanofibers, nano-fullerenes, nanotubes, hydrophobic nanoparticles or combination thereof.

108. The device of claim 106, wherein said second reaction chamber comprises a series of chambers, inter connected by a series of channels, each channel comprising metal nanoparticles.

109. The device of claim 106 wherein said device comprises an alternating arrangement of said first reaction chamber and said second reaction chamber.

110. The device of claim 106, comprises a separate channel for conveying said fluid to said first reaction chamber or second reaction chamber.

111. The device of claim 106, further comprises, at least one inlet for the introduction of carbon-based: nanoparticles, nanofibers, nano-fullerenes, nanotubes, hydrophobic nanoparticles to said first reaction chamber or metal nanoparticles to said second reaction chamber.

112. The device of claim 106, further comprises, at least one inlet for the introduction of an oxidizing agent to said second reaction chamber.

113-117. (canceled)

118. The device of claim 106, wherein said carbon-based: nanoparticles, nanofibers, nano-fullerenes, nanotubes, hydrophobic nanoparticles or combination thereof, and said metal nanoparticles are well-packed, in said reaction chamber.

119. (canceled)

120. The device of claim 106, wherein said carbon-based: nanoparticles, nanofibers, nano-fullerenes, nanotubes or hydrophobic nanoparticles or combination thereof, and said metal nanoparticles are immobilized on a solid support or embedded in a solid support.

121-124. (canceled)

125. The device of claim 106, wherein said nanotubes are single-walled or multi-walled carbon-based nanotubes.

126. The device of claim 106, wherein said carbon-based nanofibers comprise graphite.

127-130. (canceled)

131. The device of claim 106, wherein said metal nanoparticle is iron oxide, titanium oxide, titanium carbide, copper oxide, zinc oxide, silicon nitride, cerium oxide, zinc sulfide, titanium nitride or any combination thereof.

132. The device of claim 106, wherein said fluid is an aqueous solution comprising NaCl at a concentration of between about 1-5M.

133. (canceled)

134. A method of decontamination of a fluid, said method comprising applying a fluid comprising a contaminant to a device of claim 106 at ambient aerobic conditions.

135-139. (canceled)
